(19) United States
(12) Patent Application Publication
(10) Pub. No.: US 2025/0250692 A1
(43) Pub. Date: Aug. 7, 2025

(54) SUSTAINABLE METHODS AND DEVICES FOR FUEL DECONTAMINATION, FUEL PROCESSING, AND CHEMICALS PRODUCTION

(71) Applicant: Adrian Cesar Cavazos Sepulveda, San Pedro Garza Garcia (MX)

(72) Inventor: Adrian Cesar Cavazos Sepulveda, San Pedro Garza Garcia (MX)

(21) Appl. No.: 19/177,701

(22) Filed: Apr. 14, 2025

(51) Int. Cl. C25B 9/17; C01B 3/02; C01B 3/04; C25B 11/033; C25B 15/02

(52) U.S. Cl. CPC C25B 9/17; C01B 3/025; C01B 3/04; C25B 11/033; C25B 15/02

(57) ABSTRACT

A method to decontaminate a broad scope of fuels by selectively decarbonizing or desulfurizing them while producing cleaner fuels, energy, or both. The method involves the use of novel solvents, as well as novel operating schemes, and processes that reduce the thermal energy budget required to selectively produce or consume hydrogen from carbon or sulfur containing chemicals. Within the disclosure, processes are disclosed on how to circumvent throughput limitations of ionic conducting materials, balance an electrical energy grid by trading energy production for fuel production, as well as to how to tune the selectivity of an output material stream.

### PRIOR ART

U.S. Pat. No. 8,460,814B2, lacks to mention, describe, or consider an input and output stream is mentioned.

U.S. Pat. No. 8,974,939B2, lacks to mention, describe, or consider an input and output stream is mentioned.

U.S. Pat. No. 20,160,145754A1, focuses on medal oxide dissociation and lacks to mention, describe, or consider the processing of hydrocarbons and other input streams considered within this disclosure.

CN114867683A, fails to mention, describe, or consider how to integrate hydrogen production from hydrocarbons and high purity hydrogen production within a single arrangement as is herein considered and disclosed. Additionally the patent fails to describe, mention, or consider the use of chemical or electrochemical means for hydrogen production using diverse liquid or multiphase fluids.

U.S. Pat. No. 8,865,361B2, lacks to mention, describe or consider an input and output stream is mentioned.

### FIELD OF THE DISCLOSURE

This disclosure pertains to the processing of chemicals related to the energy, petrochemical, wastes industry in order to reduce their processing environmental impact by reducing their carbon content, reducing gaseous carbon containing emissions, carbolysis, hydrolysis, thiolysis, producing cleaner energy, or a combination thereof. Chemicals which could be processed include hydrocarbons, H₂S, CO₂, biomass, and plastics through chemical, thermal, and/or electrical processes enhanced with at least one of the following: solvents, catalyst, superimposed non-thermal energy inputs, alternating input streams or combining input streams.

### BACKGROUND OF THE INVENTION

Hydrocarbons (hereinafter encompassing C₁ to C₄₀ as in methane, ethane, ethylene, propane, LNG, LPG, as well as gasoline, diesel, kerosene, heavy oils, bio-sourced hydrocarbons . . . etc.) have been used to fulfill most of the world energy requirements in terms of the affordability and availability at the expense of sustainability. As an alternative methods for decarbonized, desulfurized, net-zero, or carbon negative fuels are being proposed.

Hydrogen is considered as the up and coming energy vector which could satisfy the energy trilemma of energy affordability, availability and sustainability. The current primary source for hydrogen production is through the reformation of fossil fuels such as methane (CH₄). Widely available reformation methods have a relative high carbon containing gaseous emissions, in particular when the produced CO₂ is not captured and sequestered. CO₂ capture in power plants has been estimated to require as much as an additional 40% of energy expenditure.

As an alternative, water electrolysis is posed as a low-carbon hydrogen production method, particularly when the energy is derived from renewable energy sources. That being said through a simple energetic analysis and considering no CO₂ emissions, the absolute best-case scenario for producing hydrogen from water and methane would entail, 273 KJ/mol and 50 KJ/mol (yielding 2 mol H₂), respectively. Comparatively, H₂O requires an energetic input of about an order of magnitude higher than methane. Other factors to consider include water purification, desalinization and overpotentials which are employed by current industrial electrolysis devices or steam/dry methane reforming.

That being said the volumetric energy density of gaseous hydrogen at standard conditions is unpractical for conventional transportation purposes and thus require specialized containment systems and materials such as those for liquefied (cryogenic) hydrogen, high pressure hydrogen, chemical storage, or alternatively the use of other energy vectors such as organic hydrogen carriers or ammonia, to name a few.

Of the former ammonia has an energy density comparable to hydrocarbons and is an essential precursor for the production of a plurality of products. Such that ammonia production is estimated to utilize about 1.9% of the energy produced around the world. The industrially used process for the synthesis of ammonia is the energy intensive Haber-Bosch process. Furthermore hydrogen and ammonia have been proposed to be used in electrochemical devices as a fuel source to produce primarily water and electricity. That being said hydrogen and ammonia are industrially produced in centralized facilities. A gap is yet to be filled for their relatively low temperature and pressure production at scale as well as the convenient transportation of energy vectors and its decentralized conversion to carbon emission-free energy or energy vectors whether for stationary or mobile approaches. Further potential reactants which could be processed under the scope of this disclosure at include CO₂, biomass, plastics, sour gas, acid gas or H₂S.

### SUMMARY OF THE INVENTION

An excerpt is provided of various concepts presented within this disclosure in order to facilitate a general understanding. The summary is not intended to identify key or essential features of the claimed subject matter, nor it is intended as an aid in limiting the scope of the claimed subject matter. Further aspects, details, advantages, and improvements on the subject mater will be described hereinafter to a greater extent.

In a first non-limiting example of the method in the present disclosure a supply of a hydrocarbon containing stream (extending to plastics) is contacted with or injected to a liquid electrode comprised of a liquid metal, further details below. Hydrogen, protons, or hydrides are produced and conducted selectively through a a cationic or hydride conductor towards a subsequent electrode. The process being driven by thermal, an electrochemical, electrical stimulus or a combination thereof. In other words operating in fuel cell mode, electrolysis mode or combination of both for this initial exemplary embodiment the products of focus include hydrogen, carbon, or water. Extensions to the method include feeding nitrogen concomitantly to the electrode in order to produce ammonia, carbon nitride, or further doped carbon allotropes, with the optional inclusion of further catalytic materials including but not limited hydrides, imides, nitrides, carbides, the former coating in a carbon allotrope, or a combination thereof.

In a second non-limiting example of the method in the present disclosure a supply of a H₂S containing feed is contacted with or injected to an inorganic deep eutectic solvent, comprised of at least one HₓPO_{ð}, in a solution with a metal halide salt (e.g. ZnI or ZnCl to name a few) wherein the H₂S is catalyzed to hydrogen, hydrogen halide, or both, further solvents discussed below. Optionally the method further involves the use of a membrane electrode array containing electrodes and a cationic or hydride conducting layer. The hydrogen or protons are contacted with the electrodes and are selectively conducted to a further electrode where they form either hydrogen or H₂O, depending if the method is driven in fuel cell or electrolysis mode. Further extensions to the method involve the use of nitrogen in order to produce ammonia, as part of the thiolysis process or after being produced through an electrode.

A third non-limiting embodiment involves the use of dynamic cavitation of a material stream in conjunction with specialty liquids or multiphase fluids. Examples include HₓPO_{ð}, HₓVO_{ð}, carbonates, liquid metals, inorganic deep eutectic solvents, supercritical fluids, ammonium (metal) phosphates, metal salts, nanofluids thereof, the like, or combinations thereof. The dynamic cavitation can be used for a plurality of applications, including but not limited to catalyzing a reaction (e.g. extended to photo-catalysis, synthesizing materials conventionally produced under extreme conditions, react an atomic or molecular carrier material, or producing ions, to name a few), mixing, solubilizing a material stream, producing nanofluids, or regenerate a specialty liquid or multiphase fluids, to name a few. Prior design applications consider the dynamic cavitation of a fluid as a design limitation of a mechanical or fluid system, without considering the catalytic advantages or beneficial process applications. In order to direct cavitation to the central segment of a given geometry swirling, or rotation inducing elements can be employed. Non-limiting examples include the use of a vortex diode, a Venturi injector, a Helmholtz resonator or a combination thereof with a swirling element. A particular non-limiting embodiment involves the dynamic cavitation of a liquid metal and optionally a further solvent (e.g. low electrically conductive solvent) and optionally a catalyst or adsorber/absorber in order to produce a carbon allotrope.

### BRIEF DESCRIPTION OF DRAWINGS

FIG. 1 is a diagram of a non-limiting embodiment of a method within the present disclosure, wherein an input stream is contacted with a first multiphase or liquid electrode, producing through the ionic conducting layer and onto the second electrode as well as directly through the first electrode.

FIG. 2 is a schematic of a non-limiting embodiment of an apparatus to visualize the method according to the present disclosure wherein an input material stream is reacted in a multilayered MP (defined below).

FIG. 3 is a schematic of a non-limiting embodiment of an apparatus to visualize the method according to the present disclosure wherein an input material stream is injected with a Venturi device and it is reacted in a externally circulating denser phase of the MP with internally moving solid phase (e.g. including catalysts or ad/absorbent) in the denser phase of the MP and baffles.

FIG. 4 is a schematic of a non-limiting embodiment of an apparatus to visualize the method according to the present disclosure wherein an input material stream is injected with a Venturi device into a lighter (or mixed) externally circulating MP phase followed by a vortex diode and a “pig-tail” as a vibration absorber, and moving solid phases in a dense phase of the MP as well as in a lighter phase of the MP.

FIG. 5 is a schematic of a non-limiting embodiment of an apparatus to visualize the method according to the present disclosure wherein an input material stream is reformed or catalyzed by contacting it through a Venturi device into a MP followed by an optional static mixer. Thereafter the MP is conducted through a vortex diode, an optional vibration absorber or enhancer (e.g. including a Helmholtz resonator, a “pig-tail” or both), and a further optional static mixer.

### DETAILED DESCRIPTION OF THE INVENTION

Embodiments of the present disclosure will now be described in further detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that embodiments disclosed herein may be practiced without these specific details. In other instances, well-known features or alternatives have not been described in detail to avoid further unnecessarily complicating the description. Additionally, it will be apparent to one of skill in the art that the scale of the elements presented in the accompanying figures may vary without departing from the scope of the present disclosure. Variations can include yet are not limited to at least one of the following: process step reordering, step repetition, steps omission, steps merging or combinations thereof.

Embodiments of this disclosure relate to the need to develop sustainable, clean, and efficient methods for the production and conversion of energy, energy vectors, and chemicals within the scope of the hydrogen economy and greenhouse gasses emissions avoidance.

Hydrocarbons are currently the main source of energy world wide. The main routes for producing energy or chemicals involve oxidizing fossil fuels by co-producing carbon dioxide. When the fossil fuels are oxidized, the thermal energy is conventionally converted into mechanical energy and subsequently into electrical energy. Other processes that involve using fossil fuels include hydrogen generation, which is conventionally achieved through steam methane reforming (SMR). SMR produces not only hydrogen but also carbon dioxide and potentially carbon monoxide.

Means to produce low carbon intensity energy or energy vectors involve using carbon capture techniques with subsequent carbon sequestration. Proposed capture techniques such as cryogenic carbon capture or membrane separation are currently viable for concentrated CO₂ streams. This is mainly due to the high energy intensity required for the separation processes.

Alternative methods considered as more environmentally friendly or greener, generate energy or energy vectors from low carbon or carbon-free energy sources, such as renewable energy, nuclear energy or natural hydrogen. Hydrogen and its derivatives are considered as greenhouse gas emission free energy vectors. Given the unavailability of known vast and concentrated natural sources of hydrogen worldwide, and the lack of current infrastructure to transport it, means of sourcing Hydrogen are conventionally proposed to be generated through water electrolysis while sourcing electricity with low or negligible associated carbon intensity.

Recently new methods with novel solvents have been utilized for conversion of hydrocarbons to hydrogen through pyrolysis. Pyrolysis utilizes thermal energy to separate the carbon from the hydrogen without the direct production of CO₂. That being said there is an associated CO₂ from the energy that it is spent to the drive the system. One of the advantages and part of the uniqueness of this disclosure includes a method of integrating diverse stimulus to (co)produce energy, energy vectors, and/or upcycling low value streams with a reduced or no external thermal input.

Electrochemical cells are considered as one of the most efficient types of chemical to electrical energy conversion. Additionally electrochemical devices can be tailored to perform in either energy conversion direction, e.g. chemicals-to-electricity or electricity-to-chemicals (power- to-X). Fuel cells (FC) convert chemical energy to electrical energy, whereas electrolyzers operate in the resverse direction. FCs are conventionally run with a limited number of fuels, namely hydrogen, hydrocarbons, alcohols (e.g. methanol, ethanol, iso-propanol, and so on), carbon, and recently ammonia. Hydrocarbon consuming FCs can either use a reformer or oxidize the the hydrocarbons directly in their electrodes (anodes), producing CO₂ at the expense of potential coking or poisoning. Electrolyzer cells (EC) are conventionally employed to generate hydrogen from water and are classified by their electrolyte, such as solid oxide, polymeric, alkaline, phosphoric acid, to name a few. Electrodes desirable properties include being a good mixed ionic electronic conductor (MIEC) and low overpotentials. That being said as an engineering shortcut composite electrodes are utilized, where the triple phase boundaries (boundaries where fluids, ion conductor, and electronic conductor meet) is sought to be maximized.

In this disclosure I detail several novelites pertaining to sustainable (electro) chemical methods involving liquids or multiphasic fluids comprised by at least one: liquid metal, liquid salt, inorganic deep eutectic solvent, partially inorganic deep eutectic solvent, supercritical fluid, a nanofluid comprising the aforementioned, or a combination thereof in the processing of fuels and chemicals. An (electro) chemical method and/or devices comprising at least one: liquid electrode, multiphasic fluid electrode, dynamically cavitating liquid reformer or multiphasic reformer, injecting a material by the means of the Venturi effect into a liquid or multiphasic fluid, mixing liquids or multiphasic fluids by means of the Venturi effect, a liquid or multiphasic fluids to promote oxidation of an oxygen electrode or the oxygen electrode segment ion conductor (as opposed to fuel electrode or fuel half reaction segment), or a combination thereof (hereinafter electrodes and MP are jointly referred as MP); wherein the electrodes are contacted with at least one cation or hydride ion conductor (non-limiting examples of cation conductors include monoatomic cations such as a proton conductor, polyatomic cations such as ammonium conductors, or radicals) and optionally anion conductors (non-limiting examples include a cation conductor with monoatomic anion conductors such as a proton conductor with an oxide conductor, a proton conductor with a hydride conductor, or an ammonium conductor with a hydride conductor; a cationic conductor with polyatomic anions; or a cationic conductor with radical conductor), or the electrodes are contacted with an anion extracting layer. It is to be noted that under the scope of multiphasic fluids, solid materials such as metals are comprised (e.g. including static phases). These methods have several advantages, in particularly pertaining to reducing gaseous emissions while producing electrical energy or thermal energy, catalyze reactions by providing orthogonal potentials or stimulus, thus allowing to reduce the thermal or electrical energy input for a reaction such as those to produce (decarbonized) fuels, increase the material selection space for process/reactor design, increasing the throughput of a reaction such as by reduce coking or sulfur deposition, reduce poisoning by CO₂, CO, or sulfur, increasing the number of reaction sites (e.g. triple phase boundaries), extend the reaction interface area (e.g. the one defined by an electrolyte) to a reaction volume, or increase the contact time for the reaction. Non-limiting examples of what herein is referred to orthogonal potentials include thermal energy in synergy with at least one of the following: a chemical potential (including being driven by the enthropy of mixing), electrochemical potential, dynamic cavitation, triboelectric potential, photochemical potential, photoelectric potential, photoelectrochemical potential, plasmonic potential, sonochemical potential, the like, or a combination of potentials. A particular focus is given to methane throughout this disclosure given this is one of the most thermodynamically and kinctically stable hydrocarbon. Other hydrocarbons are less thermodynamically or kinetically stable and thus generally speaking easier to process or catalyze, require less activation energy, or require lower operation temperatures. The Venturi effect is traditionally defined as the reduction in fluid pressure that results when a moving fluid speeds up as its flows from a larger cross area to a smaller area, and in most cases returning to the initial larger cross area. Nevertheless the Venturi effect has a plurality of uses beyond its traditional definition, in particular within the scope of novel fluids.

Non-limiting examples of MPs include at least one main liquid and at least one gas, at least one main liquid with at least one solid, at least two liquids, or a combination thereof. Examples of MP include but are not limited to liquid metals, molten salts, inorganic deep eutectic solvents, ionic liquids, supercritical fluids, nanofluids thereof, or a combinations thereof, in a mixture or solution with an input material stream (e.g. methane, LNG, H₂S, fossil fuels, hydrocarbons, biomass, nitrogen, COₓ, reactants, or combinations thereof), plastics (e.g. polyethylene, polystyrene, recycled, trash), solid metals (such as transition metals, semi-metals, alloys among them or with other groups such as alkali metals, or high entropy alloys thereof), metal hydrides, oxides, nitrides, sulfides, and/or combinations thereof. Further optional elements include particulates (e.g. including catalyst materials, support materials, atomic carrier materials, molecular carrier materials, inert materials, nanoparticles, or nanofluids, to name a few), electrolytes, ionic conductors, or porous matter. A further non-limiting embodiment wherein cavitation is utilized in conjunction with liquid metals, molten salts, inorganic deep eutectic solvents, ionic liquids, catalysts, a combination thereof, or a combination thereof with H₂O in order to catalyze a chemical reaction. The former could be further synergized with at least one of the following: a chemical potential, electrochemical potential, photochemical potential, photoelectric potential, photoelectrochemical potential, plasmonic potential, sonochemical potential, thermal pyrolysis, triboelectric potential, the like or a combination of potentials.

This opens a pathway for diverse FC, EC, fuel-electrolyzer-cell (FEC) and/or reformer processes and configurations. In the particular case of reformers the disclosure extends to chemical devices, details of this particular set of processes and devices will be discussed, such as through membrane production, electrode reforming production or a combination thereof such as the non- limiting embodiment of producing through the electrolyte as well as through the vent of the electrode. The latter provides an innovative production scheme where the electrolyte conductance limit could be circumvented leading to potentially diverse products or grades of the same product. A non-limiting embodiment is the co-production of hydrogen and ammonia. A further non-limiting trivial embodiment of the former mode of operation is concomitant hydrogen production and H₂O (e.g. including steam). A non-limiting embodiment involves the electrochemical production of pressurized steam for subsequent uses (e.g. including electrical energy production such as in the non- limiting examples as in turbine generators, Rankine cycles or both) through the electrochemical production of pressurized hydrogen or protons as well as oxygen or oxide ions. A non-limiting list of potential products for concomitant production include at least two of the following: hydrogen, ammonia, alcohols, aromatics, H₂O, electricity, organic hydrogen carriers, carbon-allotropes (e.g. graphite, graphene, amorphous carbon, diamonds, carbon nanotubes), carbon nitride, sulfur- allotropes, the like or a combination thereof.

A non-limiting embodiment considers the minimum theoretical energy required for the production of gaseous carbon emissions free energy vectors at standard conditions, which could theoretically be reduced from 273 (H₂O) to 25 KJ/mol (0.5 CH₄) plus diverse overpotentials. CH₄ has a neutral Gibbs free energy of about 530° C. whereas C₂H₆ is of about 230° C., whereas for CO₂ is a non-conventionally practical temperature, when a CO transition isn't considered. That is without taking into account the dissolution free energy, entropy of mixing and/or Mädelung energy, such as in the non-limiting example of I₂+H₂S=2HI+S. The reaction in air has a positive energy of formation whereas the reaction proceeds thermodynamically when in an aqueous media. Back to the case of producing a low or zero carbon emission electricity, there is a reduction in the available energy since CO₂ is not being produced. Nevertheless, the energetic penalties are lower than those of fixing that carbon to a permanent storage for distributed energy production solutions. Parting from standard conditions (or considering at 400° C.) an energy analysis for not producing CO₂ would result in a an approximate reduction in the available Gibbs free energy from 900 KJ/mol to about 500 KJ/mol (about 55%). The reduction in high quality energy is compensated when considering that only the electrical energy efficiency of a FC is of up to 60% being double the efficiency of a conventional internal combustion engine, and SOFC with cogeneration energy efficiency can be elevated between 80%- 90%. In other words the effective energy for not emitting CO₂ is roughly the same for emitting CO₂ plus the benefit of fuel flexibility, particularly for mobility applications. From an ionic conductance and kinetics perspective, a CO₂ producing SOFC methane oxidation entails the reaction of CH₄+2O₂=CO₂+2H₂O conducting 4O²⁻ ions, thus involving an 8 electrons process per CH₄, whereas for CH₄+O₂=C+2H₂O (pure hydrogen conduction) 4H⁺ are required, halving electrons involved. That being said a Lagrangian perspective of fuel utilization in order to produce decarbonized energy vectors the theoretical advantage parting from standard conditions still represents about an 90% less energy intensive source of hydrogen relative to water or from another perspective an increase of energy allocation efficiency of 1100% per molecule hydrogen. Additionally in an ideal case where they hydrogen produced from 1 mol of methane is partially oxidized, it would involve the production of 1 mol hydrogen and about 230 kJ where between 40-60% could be electrical energy for further promoting electrolysis of methane, which in a ideal case it would suffice to produce about 4 mol of hydrogen yet in practice the amount could be about 1 or 2 mol of hydrogen or less, depending drastically on temperature, solvent and catalysts used (e.g. on the onset of thermal pyrolysis it would increase drastically, for example between 400° C. and 550° C. or at a zero Gibbs free energy in the gas state of approximately 650° C. lower if dissolved). Alternatively renewable energy could be used to provide additional electrical energy or heat. That being said considering the following overall reactions 3CH₄+2N₂=3C+4NH₃ as well as 3H₂O+N₂=2NH₃+(1.5)O₂. The standard Gibbs free energy of NH₃ is −16 kJ/mol at standard conditions the energy input required per mol CH₄ to obtain a decarbonized energy vector is reduced from 50 KJ/mol to 28 KJ/mol whereas at usual production temperatures the energy increase also increases required energy e.g. +20 KJ/mol at 400° C. and thus high pressures are used to compensate. That being said the limitation is kinematic not thermodynamic e.g. surpassing the energy barriers. Alternatively higher hydrocarbons could be used which have a Gibbs free energy closer to 0 at lower temperatures facilitating their pyrolysis.

Carbon based products include carbon nitrides (CₓN_{y}), which have photocatalytic properties. The Gibbs free energy of g-C₃N₄ is non-consistently reported value e.g. including +220 KJ/mol. Just as diamonds can be synthetized in liquid media, carbon nitride might be kinetically stable although thermodynamically unstable at room temperature. g-C₃N₄ can be produced from favorable precursors such as melamine or urea at atmospheric conditions and temperatures between 400° C. and 600° C. Given the stability of molecular nitrogen, its fixation or other reactions could be activated through the use of dynamic cavitation and reduce the limitations for nitrogen containing species such as NH₃ or CₓN_{y}. During cavitation the pressure and temperature can be elevated drastically to circumvent kinematic or thermodynamic limitations. Upon cavitation, instantaneous temperatures can reach several thousands of Kelvins (e.g. up to 5000K) and localized pressures variations of thousands of atmospheres.^{[Ikeda et Matsumoto, 2008: Gogate et Pandit, 2011]} This facilitates electrochemical processes leading to the formation of radicals (e.g. including protons, methyl, ethyl, propyl, and alcohols, to name a few) and hence increase the throughput of several processes such as pyrolysis, and potentially high pressure high temperature synthesis. The synergy of the free available electrons and/or ions in non- aqueous solvents is expected to further catalyze the reactions just as in for aqueous solvents. Although there are diverse methods for inducing cavitation, the novelty of the disclosed cavitation focuses on the relatively energy favorable cavitation and subsequent effects created in MPs based in non-conventional fluids such as those created by dynamic changes in pressure or resonant waves such as those found by employing the Venturi effect, a vortex diode, or Helmholtz resonators, to name a few.

The reason why this method is of novelty is due to the versatility of processes that could be achieved. Consider reducing greenhouse gases (GHG) by CO₂ for carbon sequestration and utilization. By using a MP and a proton conductor novel pathways arise which reduce the amount of GHGs during reforming, where carbon can be captured. Consider the reforming of CH₄+CO₂→2CO+2H₂, this process requires energy input for reforming. The reaction's Gibbs free energy at room temperature is about =+119 KJ/mol and decreases with temperature, while its enthalpy requirement is ˜+247 KJ/mol. It is also to be noted that unless the CO is sequestered and not burnt it would still release GHGs. Given the properties of several MPs. let's consider the following proposed reaction CH₄+CO₂→C+H₂O+H₂+CO→2C+2H₂O. This is reaction has a Gibbs free energy at room temperature of ˜−29 KJ/mol and becomes ˜0 KJ/mol at about 300° C. while the enthalpy of reaction is ˜−15 KJ/mol. This is a kinctically hindered reaction within these temperatures in the gas state and it becomes non-spontaneous at higher temperatures; thus, requiring further energy stimulus. Similar to HI formation from H₂S when the products have a favorable enthropy of mixing the reaction could proceed in the liquid state. A molten solvent at favorable temperatures for the reaction to proceed with solubility enhancers and intermediate promoters such as carbonates, carbonyl and carbides will be further discussed below particularly considering ionic conductors. A further reaction to consider is the formation of acetic acid e.g. CH₄+CO₂→CH₃COOH. This reaction is relatively favored only at low temperatures and it conventionally involves a two step process with an intermediate methanol formation leading to a methyliodide and subsequent carbonyl addition. As mentioned earlier cavitation can induce extreme pressures and an MPs involving halides, CH₃* formation, CO₂ activation, and light excitation during cavitation will be subsequently discussed.

For the case of atomic carriers or catalysts, the cavitation could promote phase changes (e.g. topological/surface changes) which could lead to releasing the carried atom (e.g. non-limiting examples include sulfides where generally MSₓ₊₁→MSₓ+½S₂ although in select cases M′Sₓ+½S₂→M′Sₓ₊₁; imides/hydrides such as BaNₓH_{y}, graphene coated KNₓH_{y}, or core shell structures; nitrides (Mₓ′M_{y}″)₃N_{z}; or combinations thereof as in mixed anion carriers) or promote the incorporation of an atom (e.g. VₓC_{y}+CH₄→VₓC_{y+1}+2H₂). In the case of release of atoms during cavitation, the inverse reaction can be thermodynamically, kinematically or diffusion hindered when temperature and pressure is reduced, particularly in the case when the released atom forms a gas (e.g. S₂). In the case of the incorporated atom during cavitation, the additional atom is only momentarily thermodynamically stable at high temperature, pressure or both, thus facilitating the release when the temperature and pressure is reduced. Non-limiting examples of MP include liquid metals (e.g. non- limiting examples of Ga, Sn, In, Al, Li, Bi, Sb, Pb or alloys thereof such as NiₓMo_{y}Bi_{z}, ZnₓCu_{y}, ZnₓMo_{y}Ni_{z}, ZnₓMo_{y}Co_{z} with optionally other catalytic liquid or solid materials (e.g. non-limiting examples Cu, Ni, Mo, W, Os, Tl, . . . ), as well as molten salts, inorganic deep eutectic solvents (e.g. non-limiting examples metal halides mixed with HₓPO_{4-ð} including ZnCl_{ð} and HₓPO_{4-ð}, CuClₓ and HₓPO_{4-ð}, ZₙIₓ and HₓPO_{4-ð}, FeClₓ and HₓPO_{4-ð}, the aforementioned with a combinations of HₓPO_{4-ð} and H_{x′}PO_{4-ð}; the hydration or hydrosulfidation of the aforementioned; or combinations thereof), ionic conductors (e.g. phosphoric or phosphonic acid), atomic carriers, molecular carriers, adsorbants, or others further detailed in subsequent paragraphs.

The interfacial tension (IFT) of a liquid metal can be adjusted by utilizing an electrical potential. A doped liquid metal or liquid metal derived nanofluid would also adapt its IFT in more than one interface. A non-limiting embodiment considers the use of electrical or electrochemical potential not only to adjust the interfacial tension but also to optimize the mixing or separation of: a material stream in the MP, MP phases or both, as well as to: favor the synthesis selectivity towards a particular output stream (product), adjust the reaction rate, modify the MP wetting properties of a material stream, reduce the MP content in an output stream, or a combination thereof. Within the scope of this claim is the tuning of at least one of the following: power, voltage, current or a combination thereof produced by operating in at least one of the following: fuel cell mode, electrolysis mode, providing an electrical potential without ion migration through a membrane, in a shockwave electrodialysis configuration, or a combination thereof. As a non-limiting embodiment consider a multi-reactor method, wherein initially the IFT is relatively adjusted to maximize the wettability or reduce IFT towards carbon, hydrocarbons, or both. Afterwhich, in a subsequent reactor the IFT is increased to reduce the wetting of the MP and increase the recovery of the MP from an output material stream by reducing entrainment. A non-limiting embodiment entails the selective formation of a given allotrope of carbon, e.g. to favor the production of at least one of the following: diamond, graphite, graphene, buckyballs and/or carbon nanotubes to name a few. Seed or seed forming catalysts could be mixed into the MP to promote a particular allotrope or crystal structure. Examples of such materials include: BN_{ð}, Si, Ge, SiC_{ð}, GeC_{ð}, SiₓB_{y}N_{ð}, and carbon allotropes.

A further non-limiting example could further favor the production of a particular hydrocarbon (CₓH_{y}) from lower hydrocarbons (C_{x-z}H_{y′}) e.g. in order to reduce the hydrogen content of a given hydrocarbon material stream by varying the produced or applied current or voltage, even if the operating conditions are not those of peak power, voltage, and/or current.

From the commercial perspective carbon and derivatives (non-limiting examples include diamonds, carbon nitrides and aromatic hydrocarbons) have a positive commercial value rather than the emitted CO₂ which might be subjected to additional taxes or tariffs on the near future. Furthermore energy sources with low molecular carbon emissions have seen economic incentives to encourage early adopters of these technologies. Studies by Parkinson et al. (2017) have prognosed that an only chemical methane to hydrogen reformer could be economically competitive with steam methane reforming depending on reaction conditions or CO₂ taxes. That being said other high value products such as ammonia and carbon nitride were not taken into account, and an input for an additional heating source was included.

Conventional hydrogen producing technologies such as SMR or water electrolysis create an additional water demand to produce hydrogen. These technologies require a clean or sweet water, which when scaled produce an additional hydric stress on the surrounding ecosystems or dwelling. A key distinctive feature of the disclosed FEC is that it could alleviate water scarcity by producing H₂O, particularly when concomitantly producing hydrogen or electricity. From synergistic energy perspective the proposed FEC could reduce the electrical grid stress created by variable renewable energy sources by shifting the production focus on demand. The production objective can range between chemicals production and electricity production or from another perspective between clean energy storage and clean electricity production or shift to energy consumption for energy surplus scenarios. Non-limiting examples include balancing the electrical grid demand when: there is a low electricity demand by maximizing chemicals (e.g. H₂) production or for higher electrical demand reduce the chemicals production. The co-generation approach stabilizes the reactant demand in comparison to conventional means as well as avoiding FEC idle time or unnecessary demand driven ON/OFF cycles.

MP can be static, as in contained within a reactor (device), or flowing to and from a reactor. A static MP include feeding reactants (gas, liquid, solids) onto the reactor without an overall external or adjacent circulation of the main fluid or particles of the MP from the main reactor unit. Static MP could operate in a continuous mode (e.g. using a bubbler, Venturi injector or mixer) or in batch mode. A flowing MP could further include an external or adjacent circulation of the MP in order to introduce reactants, exchange heat, induce dynamic cavitation (e.g. including Venturi injectors, vortex diodes, Helmholtz resonators, self-resonators), or a combination thereof. A flowing MP could be primarily driven by pumps (e.g. mechanical energy), reactant density (e.g. bubble driven, fuel density), MP density (e.g. thermally induced density change), particulate matter, magnetic energy (e.g. comprised of magnetic particles, nanofluids, ferrofluids [e.g. including iron nitride] or a combination thereof), electrical energy, chemical potential (e.g. osmotic, electroosmotic) energy, the like, or combinations thereof (e.g. electrochemical pumps). Further elements comprising the reactor with a MP of this method could include: injectors (e.g. including Venturi injectors, ultrasonic injectors), ejectors, eductors, mixers (e.g. static mixers, vortex diodes), baffles (e.g. to direct a circulating flow of the MP or a subcomponent of the MP), stirrers, extruders, ejectors, scrubbers, heaters (e.g. include electric, microwave, solar, combustion), heat exchangers, insulation, jacket (e.g. jacketed reactor), valves (e.g. include Tesla valves, directional valves, heated valves, flow valves, etc. . . . ), sensors (flow, level, temperature, composition, magnetic, pressure, voltage, current, power), recirculators, separators (e.g. including vortex diodes, cyclones, membranes, pressure swing absorbtion, cryogenic separation, or cross-flow phases), vibration absorbers (e.g. dynamic vibration absorber, siphon, “pig tail”, or U pipe, Helmholtz resonator), solubilizing agents, adsorbants (e.g. Ag, Os, carbides or MXenes), dispersants, meshes, supporting solid metal electrodes, metallic meshes, grits, gas diffusion layers, dryer (as in H₂O), oxygen scrubber, oxygen concentrator, the like, or combinations thereof. There are additional elements which could be included and would be obvious to a skilled person in the art without deviating from the scope of this disclosure.

The MP could further include several layers or phases. In a non-limiting embodiment a MP could include more than one layer wherein one layer is at least partially stratified (e.g. a phase rises to form a layer through a density difference), such as in a non-limiting examples of a molten salt layer on top of a molten metal layer in a flowing MP, a gaseous central phase surrounded by a liquid phase in a vortex diode, a catalysts at the interface of a cavitating gas and a liquid in a vortex diode, or a high temperature oil above a liquid metal or molten salt. An additional non-limiting embodiment of an MP the electrically conductive material is a solid and the liquid or fluid phase is an ionic conductive material. Further non-limiting embodiments of further layers include dense materials, as in volumetrically dense, as particulates or solid layers (plug reactor-like, e.g. porous, low-void space, non-porous, meshes, the like) or combinations thereof. Furthermore the particulates could be placed within the MP as in a packed bed reactor or as free moving particles as in a fluidized bed reactor (e.g. as in circulated by reactants, the MP, stirrers, baffles, and or combinations thereof). Furthermore baffle materials could be used for a plurality of orientations for diverse applications, such as the non-limiting examples wherein the baffles induce the reactants or products: to rotate, facilitate removing of a given MP component (e.g. removing metals from carbon), extend reaction time, catalyze reactions, conduct ions, be polarized, extend a potential (e.g. including shockwave electrodialysis), carry atomic species, carry molecular species, act as an electromagnetic waveguide, propagate vibrations, the like or a combination thereof. In a non-limiting embodiments the diverse stratified materials could be circulated independently (e.g. in separate circuits), throughout each other (e.g. the lighter phase circulated onto the lowest segment of a heavier phase), mixed with reactants (e.g. through one or more Venturi mixers, static mixers and/or active mixers), mixed with products, the like or a combination thereof.

Diverse types of particulate matter in the MP could be classified in relation to the density of a component of the reactor as: high density, interfacial density, or low density materials. A non- limiting embodiment includes materials (e.g. carbides) with a comparable density relative to the heaviest first phase or layer of the MP and when not solubilize tend to sink to the lowest layer or be displaced to the outermost layer for rotating flows (e.g. vortex diodes). As a non-limiting example a particulate with a density of a comparable or higher value to a liquid metal, molten salt, or inorganic DES containing MP (e.g. including carbides, MXenes, nitrides, phosphides, hydrides, the like or combinations thereof) yet denser than subsequent phases. These particulates could be intended to circulate ideally within the heaviest phase, flow allowing. Interfacial density particulates with a density comparable or higher to that of the subsequent second phase or layer such that the particulate is lighter than the denser first phase of the MP. These particulates (e.g. nitrides) could be intended to circulate above the heaviest layer or to create buoyancy when circulated below the heaviest layer. Low density materials would be lighter than most if not all layers. Such materials may include diverse allotropes of carbon. Particulates could move within the reactor, adjacent circulators, external circulators, vortex diodes, Venturi injectors, orifice plates, rotor-stator, Helmholtz resonators, or a combination thereof. It would be needless to state to a person skilled in the art that a flowing MP, and to an extent a static MP as well, allows for the sequential implementation or parallelization of processes or elements without diverging from the scope of this disclosure. A non- limiting exemplar embodiment would include injecting a first input material stream onto a denser phase of the MP and in parallel injecting a second input material stream onto a lighter phase of the MP whether the denser or lighter phases are initially adjacent or not (e.g. stratified layers versus flowing phases). A non-limiting exemplar embodiment includes the dynamic cavitation of input material streams, intermediate material streams, output material streams or a combination thereof (e.g. including for initiating a reaction, stratifying phases, or recovering MP from output material streams). A non-limiting embodiment of a reactor for a the method includes a central upward flow where an input stream is injected through a Venturi and/or vortex diode, where bubbles are finely dispersed in the MP, and the MP is return on the sides of the reactor of a given phase.

Non-limiting examples of the particulates include materials comprising at least one of the following carbides, nitrides, oxides, phosphides, phosphates, ammonium (metal) phosphates, or combinations thereof e.g. W₂Cₓ, MoCₓ, VCₓ, Mo₂Nₓ, (Mo_{y}Co_{1-y})₃Nₓ, FeNₓ, LaAl_{y}Nₓ, SiO₂₋ₓ, Al₂O₃₋ₓ, ZrO₂₋ₓ, CeO₂₋ₓ, as well as further known support materials (e.g. including graphene, silicene, CₓN_{y}, to name a few) and/or electrochemically active materials including perovskites, fluorites, bronzes and related structures. Furthermore the particulates must not be homogeneous. Particulates range in scales from sub-nanometer to centimeters and could have heterogenous layers resulting in heterostructures such as having composites, chainmail structure, core-shell structures, graded structures, functional groups, eutectic structures, Janus structures, ex-solutions, single atom catalyst, to name a few. Further non-limiting examples include LaₓSr_{y}Cr_{z}Mn_{w}O_{3-ð}, GdₓCe_{y}O_{2-ð}, SmₓCe_{y}O_{2-ð}, YₓCe_{y}O_{2-ð}, LaₓSr_{y}Co_{z}Fe_{w}O_{3+ð}, SrₓMo_{y}Mn_{z}O_{ð}, ErₓDy_{y}Bi_{z}O_{2-ð}, YₓZr_{y}O_{2-ð}, (NHᵤ)ᵥLi_{w}MoₓCo_{y}P_{z}O_{ð}, (NH_{w})ₓM_{y}P_{z}O_{ð} (where M is at least one metal), as well as electrolyte and solid materials discussed in subsequent paragraphs.

MP components, phases or layers of the MP could include combinations of diverse salts, metals or others. Combinations of diverse salts, metals, H₂O, H₂S, or combinations thereof could further lead to the formation of eutectic mixtures or inorganic deep eutectics mixtures (IDES), which could further comprise the MP. In general components of the MP include the non-limiting examples of combinations of:
chloride salts,
phosphates or pyrophosphates (e.g. (NH_{w})ₓP_{y}O_{ð}, (NH_{w})ₓM_{y}P_{z}O_{ð} [where M is at least one metal, such as Sn, In, Mg, Mn, Ga, Mo, Ce, Cu, or Ni, to name a few],
phosphorous containing acids,
phosphorous containing iDES (e.g. H₃₋ₓPO_{4-d} including with ZnClₓ, CuClₓ, MoClₓ, CoClₓ, BiClₓ, NiClₓ, PClₓ, LiCl, LiF, FeCl_{ð} and other metal halides, the like, or mixtures thereof as well as mixtures comprising more than one stoichometry of a phosphorous containing acid, such as including H₃₋ₓPO_{4-ð}, H_{3-x′}PO_{4-ð′}, (NH_{w})ₓP_{y}O_{ð}, (NH_{w})ₓM_{y}P_{z}O_{ð}, or combinations thereof),
nitrates (e.g. including based on Li, Na, K, P, and Ca, to name a few),
carbonates (e.g. including based on Li, Na, K, anc Ca to name a few),
vanadates (e.g. including NaₓV_{y}O_{ð}, LiₓV_{y}O_{ð}, KₓV_{y}O_{ð}, (NH_{w})ₓV_{y}O_{ð}),
phosphovanadates,
vanadic acid (e.g. including vanadic acid, or combinations of vanadic acid with H₃₋ₓPO_{4-d},),
alkali halides (e.g. including high entropy mixtures such as those including vanadates, molybdates, ammonia, the like, or combinations thereof or subsets thereof, such as the non-limiting system comprising LiF—KBr—KₓV_{y}O_{ð}—LiKMo_{y}W_{z}O_{ð}),
oxides (e.g. VₓO_{ð}, MoₓO_{ð}, WₓO_{ð}, Hₓ—Li_{y}Mn_{z}O_{ð}, Hₓ—Sr_{y}Co_{z}O_{ð}, SiₓO_{ð}, AlₓO_{ð}, CeₓO_{ð}, Y_{y}ZrₓO_{ð}, MgO_{ð}, TiO_{ð}, NiO_{ð}, FeₓO_{ð}, Li_{w}NiₓCo_{y}Al_{z}O_{ð}, La_{w}SrₓCr_{y}Mn_{z}O_{ð}, La_{w}SrₓCo_{y}Fe_{z}O_{ð}, Ba_{w}SrₓCo_{y}Fe_{z}O_{ð} or combinations thereof),
liquid metals (e.g. including Li, Ga, Zn, Sn, In, Mg, Mn, Al, Sb, P and alloys including NiₓMo_{y}Bi_{z}, ZnₓCu_{y}, ZnₓMo_{y}Ni_{z}, CuₓNi_{y}Sn_{z}, ZnₓMo_{y}Co_{z}, ZnₓSn_{y}, SnₓBi_{y}, SnₓPb_{y}, ZnₓPb_{y}, BiₓPb_{y}, ZnₓGa_{y}, TlₓPb_{y}, TlₓGa_{y}, TlₓZn_{y}, as well as doping with catalytic elements such as Cu, Ni, Mo, W, Co, Fe, Ag, V, Ir, Pt, Dy, Ru, Os, Si, Ge, Tl, to name a few and not to be bound by current theory extending to liquid Na, Cs, Bi, or Ce, as well as by current preventive environmental restrictions Hg, the aforementioned partially oxidized, the like, or combinations thereof),
ionic liquids,
catalysts (e.g. metals such as transition metals including Pt, Ru, Rh, Ir, Ag, Re, Pd, Au [e.g. photocatalytic], In, Cd, Al or combinations thereof; nitrides such as MnₓN_{y}, MoₓCo_{y}N_{z} carbides including pristine, carbon-allotrope coated, nitrogen or phosphide doped carbides such as FeₓC_{y}, MoₓC_{y}, WₓC_{y}, WₓC_{y}N_{z}P_{ð}, TiₓC_{y}, NiₓC_{y}, CoₓC_{y}, CrₓC_{y}, RuₓC_{y}, PtₓC_{y}, BaₓC_{y}, SrₓC_{y}, CaₓC_{y}, compounds thereof e.g. MnᵤNᵥMo_{w}CoₓNi_{y}C_{z}—Ba_{α}H_{ð}, MnₜNᵤWᵥMo_{w}CoₓNi_{y}C_{z}—Ba_{α}H_{ð}, MnₛNₜVᵤFeᵥMo_{w}CoₓNi_{y}C_{z}—Ba_{α}H_{ð}, [to mention a few] the afore mentioned decorated with transition metals such as noble metals [Ru, Pt, Os, Ir], photo-catalysts/plasmonic catalysts including MoₓS_{ð}, CuₓZn_{y}Sn_{z}S_{ð}, CuₓIn_{z}S_{ð}, CuₓSb_{z}S_{ð}, CdₓS_{ð}, TiₓN_{α}O_{β}C_{γ}S_{ð}, ZrₓN_{α}O_{β}C_{γ}S_{ð} and VₓN_{α}O_{β}C_{γ}S_{ð}, high entropy alloys including CoᵤNiᵥCu_{w}RuₓPd_{y}Pt_{z}V_{ð}, CoᵤMoᵥFe_{w}NiₓCu_{y}W_{z}V_{ð}, IrᵥPd_{w}RhₓRu_{y}Pt_{z}V_{ð}, TiᵤVᵥCr_{w}MnₓMo_{y}Ce_{z}, NiᵤCo_{w}FeₓCr_{y}Pt_{z}V_{ð}, AlᵥNi_{w}CuₓPt_{y}Mn_{z}, PtᵥRh_{w}MoₓFe_{y}Mn_{z}, the catalyst support such as SiO_{ð}, TiO_{ð}, AlO_{ð}, AlₓMg_{y}O_{ð}, ZrO_{ð}, CeO_{ð}, Si, Ge, BₓN_{y}, GaₓAs_{y}, and further examples below),
supercritical fluids (e.g. including CH₄, H₂S, H₂O, COₓ, light hydrocarbons or alcohols to name a few),
atomic carriers or molecular carriers (e.g. hydrogen carrier, nitrogen carrier, oxygen carrier, carbon carrier, sulfur carriers, the like or combinations thereof),
ionic conductors (e.g. proton conductor, hydride conductor, oxide conductor, ammonium conductor, hydroxide conductor, or lithium conductors to name a few),
adsorbing, solubilizing, or dispersing agents (e.g. for hydrocarbons such as methane, including Osmium and Os derived compounds, carbides/MXenes such as VₓC_{y}, TiₓC_{y}, MoₓC_{y}, WₓC_{y}, BaₓC_{y}, SrₓC_{y} as well as YₓC_{y}, CrₓC_{y}, HfₓC_{y}, ZrₓC_{y}, TaₓC_{y}, CeₓC_{y}, LaₓC_{y}, GdₓC_{y}, rare earth carbides or compounds in between; as well as other material streams such as zeolites and other molecular sieves),
high-temperature oils (silicon oils, polydimethylsiloxane, diphenyl-dimethylsiloxane, phenylmethylsiloxane, “Fragol” style silicon oils, diphenyl oxide/biphenyl eutectics, perfluoropolyethers, or nanofluids thereof.)
partially inorganic DES (iDES doped with organic materials, including: choline halides, urea, (di)carboxylic acids, ADP. ATP, ethylene glycol, PEG, ethylene oxide, PEO, polyethylene dimethyl ether, polyethylene monomethyl ether, polypropylene dimethyl ether, polypropylene monomethyl ether, propylene glycol, PPG, ethoxylates, alcohol ethoxylates, poloxamers, to name a few)
further particulate mater, the like, combinations thereof or subsets thereof.

The solid phase including fixed or freely moving materials. Solid materials could include the non-limiting examples of carbides, phosphide, phosphates, sulfides, nitrides and M(A)Xenes include: vanadium carbides, tungsten carbides, molybdenum carbides, molybdenum nitrides, molybdenum cobalt nitrides, iron nitrides, lanthanum nitride, lanthanum aluminum nitride, aluminum nitride, iron nitride, lithium nitride, molybdenum phosphide, cobalt phosphide, lithium phosphate, molybdenum phosphate, vanadium phosphide, molybdenum sulfide, mixtures thereof, the former doped with a transition metal or semi-metal, the former wherein further anionic species are doped or mixed. As non-limiting examples one could include materials having an overall composition of at least one of the following: Mo_{y}(CN)_{0.5-x}, doped V_{w}Cₓ, V_{w}CₓN_{α}C_{β}S_{γ}, VₓP_{y}C_{1-z}, Fe_{y}V_{z}CₓN_{w}, Ti_{y}V_{z}CₓN_{w}, Mo_{y}CO_{z}CₓN_{w}, LiᵥV_{w}MoₓCo_{y}W_{z}N_{α}C_{β}S_{γ}, LiᵤFeᵥV_{w}MoₓCo_{y}W_{z}N_{α}C_{β}S_{γ}, LiᵤTiᵥV_{w}MoₓCo_{y}W_{z}N_{α}C_{β}S_{γ}, LiᵤNiᵥV_{w}MoₓCo_{y}W_{z}N_{α}C_{β}S_{γ}, and LiᵤCuᵥV_{w}MoₓCo_{y}W_{z}N_{α}C_{β}S_{γ} and rare earth phosphide-carbides wherein the subscripts range from 0 to 1 including all values between 0 and 1, 0, and 1. These materials can serve as catalysts or atomic carriers (e.g. for at least one or more of the following: hydrogen, carbon, nitrogen, sulfur, or a combination thereof). The extensive listed anions in the stoichiometry are included to accommodate for diverse stoichiometries or heterostructures such as composites, chainmail, core-shell, graded structures or functional groups where carbon or carbon nitride (to mention a few) can coat the atomic carrier or catalyst in order to facilitate the kinetics or thermodynamics of the process.

Furthermore by utilizing a MP the (electro) chemically active area or electrochemically conductive area is not limited to the electrolyte area, and extends to the surface of the contact area between the reactive species and the MP, or as an approximation it extends to the whole volume rather than the surface of a solid electrode. It should be emphasized particularly when cavitation is used to disperse the reactant in the multiphasic element. In addition to that reactant absorbing. dispersing, or solubilizing materials could be employed in the MP to further facilitate the mixing or solubilization. A particular case of methane adsorption, dispersion or both in a molten salt or liquid metal could entail the use of carbides or carbide based nanofluids such as VₓC_{y}, TiₓC_{y}, MoₓC_{y}, WₓC_{y}, YₓC_{y}, transition metal carbides or rare earth carbides as well as metals with an affinity to methane such as osmium. Furthermore cavitation can induce a stoichiometric variation in materials such as for the non-limiting examples of nitrogen or carbon: fixation, release, and/or exchange in atomic carriers. As mentioned earlier rising the temperature of a material can induce a phase change or surface reaction such as the non-limiting example processes of AₓC_{y}+C=AₓC_{y+1}, AₓC_{y}+CH₄=AₓC_{y+1}+2H₂ or AC_{w}+xN₂+yCH₄=AC_{w′}+x′NH₃+y′CᵤN_{z} wherein A is a metal or alloy selected from transition metals, rare earths, actinides, or lanthanides. Additionally vortex diodes and Venturi devices can control the cavitation zone whether to be in the center of the exit port, closer the walls of the reactor, or in between. This is intended to enhance the lifetime of the dynamic cavitating component. Cavitation zone placement can be achieved by a plurality of means such as the non- limiting examples of selecting the rotation speed, device dimensional design, flow adjustment, operational pressure adjustment, or the addition of further ports e.g. collinear with the exit port of a vortex diode.

Electrolyte materials can be found in diverse states such as solids or liquids. As it would be obvious to any skilled in the art, materials, phases or layers can function for a given application or multiple ones (e.g. electrolyte & catalyst, electrolyte & solvent, adsorbant & carrier, to name a few). Hence, the comprehensive material compilation for MPs would encompass materials with other primary applications as described within this disclosure. That being said any person skilled in the art would readily comprehend that there are numerous electrolyte materials and could easily fit within the scope of this disclosure. MP components include electrolyte materials and solid metals. Electrolyte materials consist of at least one of:
polymeric ion conductors (e.g. Nafion, polybenzimidazole [PBI], polypyridobisimidazole [PPI], polyethersulfone [PES], polyvinylpyrrolidone [PVP], PTFE, sulfonates, and the aforementioned dopped with diverse acids),
phosphoric acid,
phosphonic acid and related materials (ethylenediamine tetramethylene phosphonic acid, or variants with longer carbon chains or hyperbranched e.g. C_{y}N₂(C_{z}PO₃H₂)₄),
hydroxides (e.g. NaOH, KOH),
oxides (e.g. BaₓZr_{y}Y_{z}O_{3-ð}, BaₓCe_{y}Y_{z}O_{3-ð}, Ba_{w}ZrₓCe_{y}Y_{z}O_{3-ð}, BaᵤZrᵥCe_{w}YₓYb_{y}O_{3-ð}, BaᵤZrᵥSn_{w}TiₓHf_{y}Y_{z}O_{ð}, BaᵤZrᵥGa_{w}TiₓHf_{y}Y_{z}O_{ð}, SmₓNi_{y}O_{3-ð}, Sr_{w}FeₓTi_{y}Zn₂O_{ð}, PrᵤBaᵥZr_{z}Ce_{y}Y_{z}YbₛO_{3-ð}, NbₓTi_{y}O_{3-ð}, HₓSr_{y}Co_{z}O_{ð}, HₓLi_{y}Mn_{z}O_{ð}, HₓMo_{y}O_{ð}, HₓW_{y}O_{α}, La_{w}SrₓGa_{y}Mg_{z}O_{ð}),
inorganic DES (e.g. HₓP_{y}O_{ð}, MᵥN_{w}HₓMo_{y}O_{ð}, MᵥN_{w}HₓW_{y}O_{ð}, and/or MᵥN_{w}HₓB_{y}O_{ð}, with ZnCl_{ð}, CuCl_{ð}, MoCl_{ð}, CoCl_{ð}, BiCl_{ð}, NiCl_{ð}, PCl_{ð}, LiCl, LiF, and other metal halides, the like, or mixtures thereof as well as mixtures comprising more than one stoichometry of a phosphorous containing acid, such as including H₃₋ₓPO_{4-ð}, H_{3-x′}PO_{4-ð′}, (NH_{w})ₓP_{y}O_{ð}, (NH_{w})ₓM_{y}P_{z}O_{ð}, or combinations thereof)
ionic liquids,
molten salts (e.g. n-ammonium metal phosphates (NᵤHᵥM_{w}P_{z}O_{α}Cl_{β}) e.g. having an overall composition of NᵤHᵥSn_{w}GaₓZn_{y}P_{z}O_{α}Cl_{β}, LiX:KX:V_{z}O_{α}:HₓMo_{y}O_{α}:H_{x′}W_{y′}O_{α″}:H_{x″}Sr_{y″}Co_{z″}O_{α′″} where X is at least one halide, as well as the aforementioned nitrates, carbonates),
NHₓ conductors (e.g. including VₓO_{ð}, metal ammonium phosphates, metal ammonium pyrophosphates, TiₓC₂Tₓ),
phosphates (e.g. including SnₓIn_{y}PO_{α}Cl_{β}, (NH_{w})ₓP_{y}O_{ð}, (NH_{w})ₓM_{y}P_{z}O_{ð} [where M is at least one metal, such as Sn, In, Mg, Mn, Ga, Mo, Ce, Bi, Th, V, Cu, or Ni, to name a few]), ammonium based perovskites/bronze-like structures (e.g. ammonium metal halides including NₓH_{y}Mg_{z}Cl_{α}, NₓH_{y}Ti_{z}F_{α} or to generalize NₓH_{y}M_{z}X_{α} where M is at least one metal and X is at least one halide),
hydrides, imides, nitrides and heterostructures thereof (e.g. including BaₓN_{y}H_{z}, Mn_{w}NₓBa_{y}H_{z}, NiₓBa_{y}H_{z}, NiᵤCoᵥMn_{w}NₓBa_{y}H_{z}, MoᵤCoᵥMn_{w}NₓBa_{y}H_{z}, FeᵥMn_{w}NₓBa_{y}H_{z}, LaₓN_{y}H_{z}, LiₓN_{y}H_{z}, CaₓN_{y}H_{z}, VN_{y}H_{z}, TiN_{y}H_{z}, MoᵤCoᵥMn_{w}NₓK_{y}H_{z}, MoᵤCoᵥMn_{w}NₓNa_{y}H_{z}, FeᵥMn_{w}NₓK_{y}H_{z}, FeᵥMn_{w}NₓNa_{y}H_{z} as well as their encapsulation [core-shell/chainmail] in a carbon-allotrope such as graphene)
palladium (e.g. palladium membranes including doped with Ag, Au, Pt, Cu, H, to name a few.)
carbides (e.g. SiC, and others previously mentioned, particularly considering their mechanical and chemical stability, such as when used as electrolyte support)
the aforementioned in a hydrated state or mixed with H₂O,
the aforementioned containing H₂S,
combinations thereof, or subsets thereof.

Molten salts with conductive components have a promising performance such as HₓMo_{y}O_{α}, HₓW_{y}O_{α}, HₓSr_{y}Co_{z}O_{α}, which have shown high proton conductivities in the solid state as well as VₓO_{α}, MoₓO_{α}, WₓO_{α}, and some ammonium (metal)polyphosphates and ammonium (metal) phosphates.

Further MP components could include the not limiting examples of combinations of: chloride salts, phosphate salts, plasmonic materials (e.g. including TiN_{α}O_{β}C_{γ}S_{ð}, ZrN_{α}O_{β}C_{γ}S_{ð} and VN_{α}O_{β}C_{γ}S_{ð}), sulfides (e.g. AuₓLi_{y}S_{ð}, MoS_{ð}, Au_{z}Li_{y}S_{ð}, VₓCu_{y}So_{ð}, or CuᵥZnₓSn_{y}S_{ð}), hydroxides (e.g. including Niₓ(OH)_{y}, Cuₓ(OH)_{y}, and other transition metal hydroxides), fluorides (e.g. including silver fluroide, and other transition metal fluorides as well as PTFE, PVDF, fluorinated polymers or fluorocarbons), dimethylformamide (DMF) and related salts, guadinine and related salts, formamidine related salts or a combination thereof. Further non-limiting examples of catalyst, catalyst support or both, are comprised of at least one of the following: Li, Mn, Mg, Ca, Ce, Bi, Zr, Al, V, Zn, Co, Cu, Ni, In, as in the non-limiting combinations of anion carriers or composite anion carriers comprising an overall composition of: Ce_{α}Mn_{β}CₓS_{y}N_{z}O_{ð}, Ce_{α}Au_{β}CₓS_{y}N_{z}O_{ð}, Ce_{α}Pt_{β}CₓS_{y}N_{z}O_{ð}, Ce_{α}Li_{β}CₓS_{y}N_{z}O_{ð}, Ce_{α}Li_{β}Mn_{γ}CₓS_{y}N_{z}O_{ð}, Ce_{α}Li_{β}Mn_{γ}Bi_{δ}CₓS_{y}N_{z}O_{ð}, Ce_{α}Li_{β}Mn_{γ}Bi_{δ}Au_{ε}CₓS_{y}N_{z}O_{ð}, Ce_{α}Li_{β}Mn_{γ}Bi_{δ}Pt_{ε}CₓS_{y}N_{z}O_{ð}, Ce_{α}Li_{β}Mn_{γ}Bi_{δ}Ag_{ε}CₓS_{y}N_{z}O_{ð} the aforementioned doped with Gd or Sm, Li_{α}Mo_{β}CₓS_{y}N_{z}O_{ð}, Mn_{α}MO_{β}CₓS_{y}N_{z}O_{ð}, Li_{α}Na_{β}CₓS_{y}N_{z}O_{ð}, Li_{α}Na_{β}P_{ð}SₓC_{y}N_{z}O_{ð}, Li_{α}Ge_{β}P_{γ}CₓS_{y}N_{z}O_{ð}, Li_{α}Na_{β}P_{γ}CₓS_{y}N_{z}O_{ð}, Li_{α}Si_{β}P_{γ}CₓS_{y}N_{z}O_{ð}, Li_{α}Na_{β}Sr_{γ}Zr_{δ}P_{ε}CₓS_{y}N_{z}O_{ð}, Li_{α}Na_{β}Mn_{γ}Mg_{δ}Zn_{δ}P_{w}CₓS_{y}O_{ð}X_{z}, Li_{α}Si_{β}P_{γ}X_{δ}CₓS_{y}N_{z}O_{ð}, Li_{α}La_{β}Zr_{γ}CₓS_{y}N_{z}O_{ð}, Li_{α}La_{β}Ce_{γ}CₓS_{y}N_{z}O_{ð}, Li_{α}Na_{β}Zr_{γ}P_{δ}CₓS_{y}N_{z}O_{ð}, Li_{α}Ce_{β}P_{γ}CₓS_{y}N_{z}O_{ð}, CaCₓS_{y}N_{z}O_{ð}, AgLiCₓS_{y}N_{z}O_{ð}, MnCₓS_{y}N_{z}O_{ð}, MgCₓS_{y}N_{z}O_{ð}, ZnCₓS_{y}N_{z}O_{ð}, Li_{α}Y_{β}Zr_{γ}CₓS_{y}N_{z}O_{ð}, Mn_{α}Y_{β}Zr_{γ}CₓS_{y}N_{z}O_{ð}, Mg_{α}Y_{β}Zr_{γ}CₓS_{y}N_{z}O_{ð}, Ca_{α}Y_{β}Zr_{γ}CₓS_{y}N_{z}O_{ð}, Li_{α}V_{β}CₓS_{y}N_{z}O_{ð}, La_{α}Sr_{β}V_{γ}CₓS_{y}N_{z}O_{ð}, Gd_{α}aTi_{β}Mo_{γ}CₓS_{y}N_{z}O_{ð}, Bi₆₀ Me_{β}V_{γ}CₓS_{y}N_{z}O_{ð}, Dy_{α}Gd_{β}Bi_{γ}Li_{δ}CₓS_{y}N_{z}O_{ð}, Dy_{α}Gd_{β}Bi_{γ}Mn_{δ}CₓS_{y}N_{z}O_{ð}, Dy_{α}Gd_{β}Bi_{γ}Ca_{δ}CₓS_{y}N_{z}O_{ð}, BaZrYCₓS_{y}N_{z}O_{ð}, BaCeYCₓS_{y}N_{z}O_{ð}, Co_{α}Ni_{β}Zn_{γ}In_{δ}CₓS_{y}N_{z}O_{ð}, Li_{α}Na_{β}Me_{γ}Te_{ε}CₓS_{y}N_{z}O_{ð}, Me, Me exsolutions, MeCₓS_{y}N_{z}O_{ð} exsolutions, solutions thereof, the aforementioned carbon allotrope coated (e.g graphene) coated, the aforementioned carbon allotrope encapsulated, or combinations thereof, Me is comprised of at least one of the following: a transition metal (e.g. including but not limited to: Mn, Au, Ag, Rh, Ir, Re, Ni, Co, Zn, Ta, Nb), Li, Ca, Mg, Sr, Ba, Na, K, Nd, a lanthanide (e.g. including but not limited to: Ce, Sm, Dy, Er, La, Pr, to name a few) or combinations thereof, and X is a halide (e.g. Cl, I, F, Br).

### METHODS

In one aspect, the embodiments herein relate to a system for processing an input stream to produce an output stream by a plurality of means e.g. by contacting with an MP, an ionic conductor layer and a subsequent electrode, and optionally a catalyst, a catalyst support, and a combination thereof, at a given state to produce a hydrogen containing output material stream, an ammonia containing output stream, or further output streams detailed below. Such embodiments relate to steps or procedures which could be conducted concomitantly, sequentially, parallelized, in one or more reactors as well as skipping, merging or adding features, phases, steps or procedures without deviating from the present disclosure.

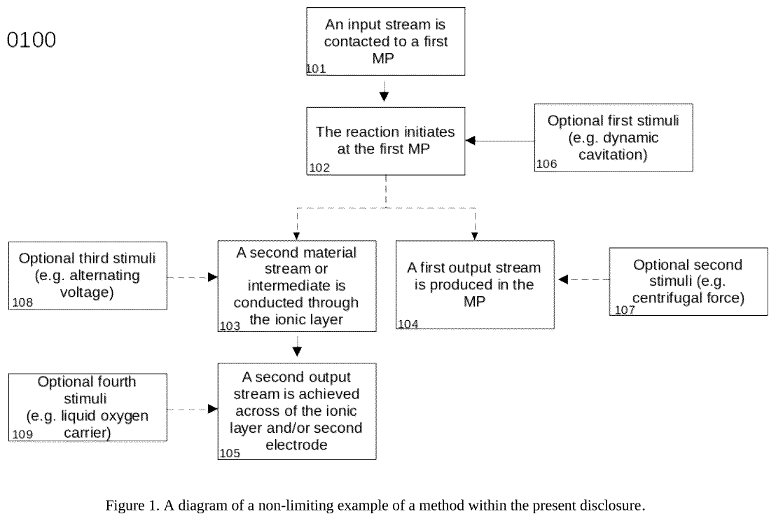

In a non-limiting embodiment, a method of operation is illustrated as in FIG. 1. Where a an input stream 101 is contacted with the first MP. The input stream becomes part of the MP and starts to react 102, optionally with a stimulus 106 such as dynamic cavitation, a photonic stimulus, or an adsorbant, an electrical potential, heat, to name a few. Afterwards part of the stream is conducted through an ionic layer 103 with an optional stimulus 108 such as applied electrical potential including AC voltage, DC voltage (e.g. as in an open circuit potential) or both, while the rest of the stream is produced through the MP 104. A further optional stimulus 107 could be applied to 104, which could include centrifugal force, removing impurities, rotation with the baffles, an electrical potential, an electrical potential through a polarizable grit (e.g. silicates) or passing through further phases. Some of the initially reacted input material stream might be catalyzed yet not be conducted through the ionic layer and due to density differences, MP circulation, or any additional factors and is produced as part of the first output material stream 104.The stream 103 is further produced through the second electrode or ionic layer where a further optional stimulus 109 such as a nitrogen stream. an oxygen stream or an oxygen ion bearing stream (e.g. including carbonates) is further reacted with the stream in order to produce the output stream 105. Note that the stimuli are not limited to a specific section of the method and can be applied in diverse segments of the method.

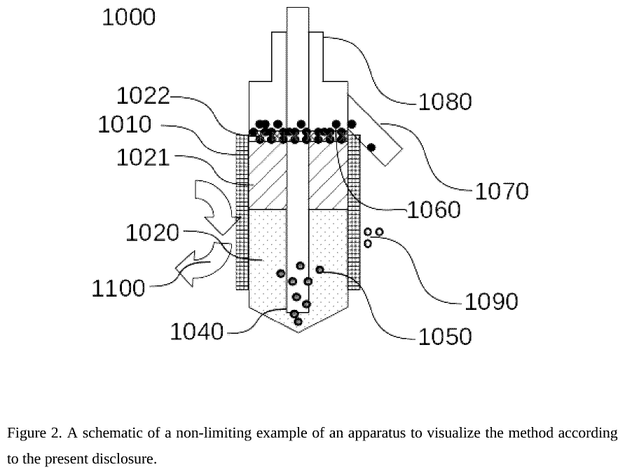

FIG. 2 is a schematic of a non-limiting embodiment of an apparatus to visualize a subset of a method 1000 according to the present disclosure wherein an input material stream 1050 is contacted through an injector 1040 (optionally with a Venturi device, not shown) with the denser first segment 1020 (e.g. liquid metals, iDES, molten salts, carbides, to name a few) of an MP (1020, 1021, 1022). The stream is further contacted with an ionic conducting layer 1010 (e.g. SNO, BCZYYb, LMO, SIPO, BCZY, HSCO, EDTMP+HPO, HMO, to name a few) producing an ionically conducted partial material stream, and subsequently with the second electrode (not shown, e.g. BCFZY, NCAL, Pd, Pd alloy, BSCF, to name a few) through a plurality of means (directly, or electrically/electrochemically through the MP). Anyone skilled in the art would casily identify further suitable ionic conducting materials, or MIEC materials. The partial material stream is further reacted with an input material stream or second phase of the MP 1100 (e.g. containing air, oxygen, nitrogen, ionic carriers, carbonates, atomic carriers, nitrates and/or molten metals, to name a few), hence producing an output material stream 1090. Note that an additional structure (not shown) containing: a fluid, a second MP 1100, or acirculating second MP 1100 could encase the shown reactor. Optionally the non-ionically conducted material stream further traverses a lighter phase of the MP 1021 (e.g. iDES, molten salts, high temperature oils), and a further optional lighter top phase 1022 (e.g. high temperature oils, water, to name a few.). A further optional MP layer is not shown, (e.g. long columns with a notable temperature difference could accommodate a heavy high temperature oil with a specific density above 1 and a subsequent optional aqueous layer, optional organic solvent layer or both on top). The top phase being 1022 being of a comparable density of the solid output material stream 1060 yet denser than a fluid output material stream (not shown, optional). The fluid output stream is evacuated through 1080, whereas 1060 is evacuated through 1070. Optionally 1080 and 1070 could be a single element. Furthermore, several (not shown) actuating mechanisms or fluid designs (e.g. siphon, “U” trap) are envisioned as previously disclosed in order to avoid leakage when output material streams are evacuated through diverse conduits. Optionally (not shown) the method may include further ionic layers (e.g. oxide extracting layer), electrodes or both, wherein optionally the electrodes are connected in series or in parallel with at least one of aforementioned electrodes.

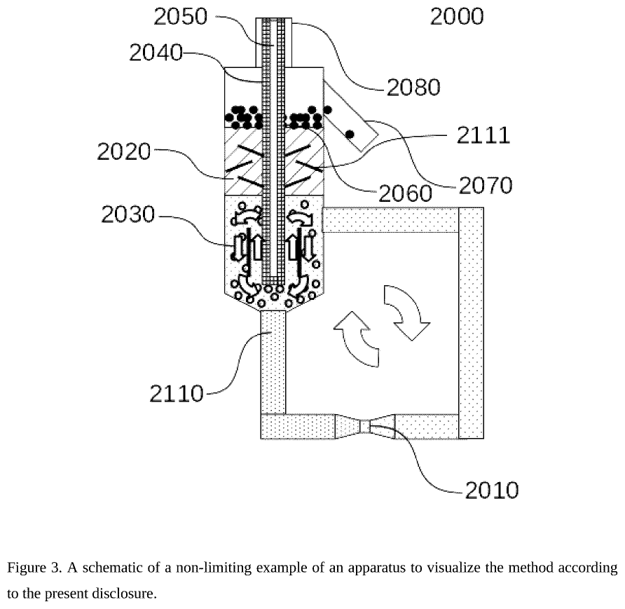

FIG. 3 is a schematic of a non-limiting embodiment of an apparatus to visualize a subset of a method 2000 according to the present disclosure wherein an input material stream (not shown) is contacted through an injector 2010 (e.g. a Venturi device, bubbler, stator rotor, to name a few) with an MP 2110 in an externally circulated (not show, optionally with a pump, screw, or density to name a few) in a denser phase of the MP (e.g. containing carbide adsorbants, solubilizing agents, or molecular sieves, to name a few) and it is conducted along the MP in order to be contacted with a moving solid phase 2030 (e.g. catalysts) in the denser phase of the MP. A partial material stream is conducted through an ionic layer 2040, and further through a second electrode (not shown) optionally with a further stimulus such as an electrical stimulus (not shown e.g. from a potential produced through an uncoupled ionic conductor). The partial material stream 2040 further being evacuated through conduit 2050. The non ionically conducted material stream subsequently contacts a lighter phase of the MP 2020 wherein it is further contacted with elements within the MP such as baffles 2111 or catalysts. The material stream further being conducted to produce a solid material output stream 2060 and a fluid material output stream (not shown) evacuated through 2080. The solid material output stream being evacuated through 2070.

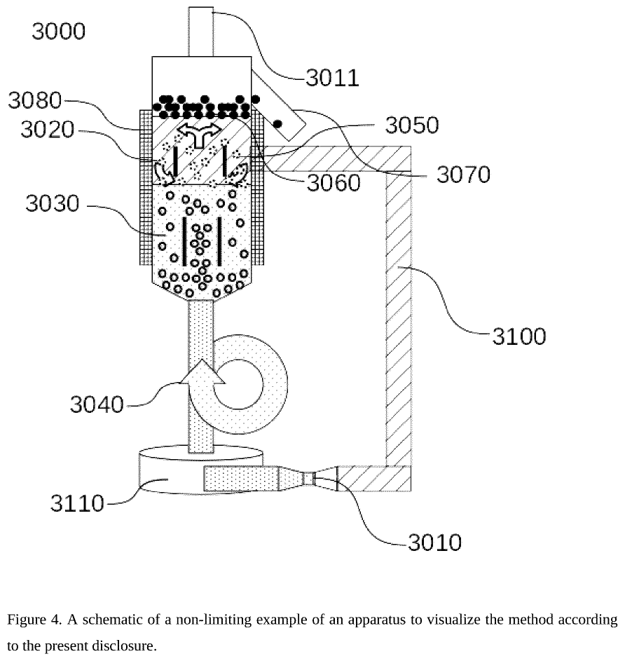

FIG. 4 is a schematic of a non-limiting embodiment of an apparatus to visualize a subset of a method 3000 according to the present disclosure wherein an input material stream is contacted with an injector 3010 (e.g. with a Venturi device, or a Venturi device with an additional stimulus such as an electric potential whether AC, DC or both, such as in the non-limiting example to tune the interfacial tension of the MP and a material stream, particularly on an MP with particulates, a nanofluid, as well as low dimensional semiconducting or insulating materials) into a lighter (or mixed) externally circulating MP phase, optionally wherein the material stream is dynamically cavitated, mixed or both. Optionally a lighter phase could be contacted with other phases through the use of subsequent Venturi injectors. The material stream further being conducted through a vortex diode 3110, optionally wherein the material stream is dynamically, and subsequently through a vibration absorption element 3040 (e.g. Helmholz resonator, “pig-tail” or “U” shape conduit, to name a few). The material stream further contacted to the a denser MP phase or phases 3030, with a fluidized bed of moving solid phases (e.g. catalysts). The material stream further being contacted with an ionic conductor 3080 as well as a lighter phase of the MP 3020. The lighter phase having moving solid phases 3050, and is being externally circulated through 3100, further optional elements include meshes or grits. The non-ionically conducted material stream further producing a solid material output stream and a fluid material output stream (optional), conducted through 3070 and 3080, respectively.

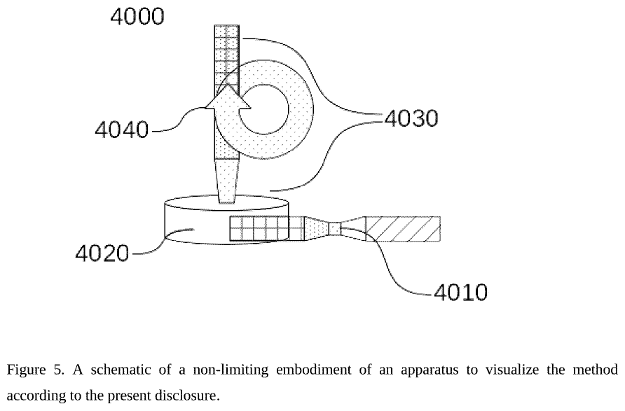

FIG. 5 is a schematic of a non-limiting embodiment of an apparatus to visualize a subset of a method 4000 according to the present disclosure, wherein an input material stream is reformed by contacting it through a Venturi device 4010 into a MP followed by an optional static mixer 4030. Thereafter the MP is conducted through a vortex diode 4020, an optional vibration absorber or amplifier 4040 (e.g. Helmholtz resonator, “pig tail”, to name a few), and a further optional static mixer 4030. Further elements (not shown) could include pumps, valves, screws, or other elements discussed earlier. The method could be operated on an average MP pressure between 0 atm to about 500 bar, average temperatures between −40° C. to 1400° C. while localized temperatures and pressures can surpass those ranges.

A non-limiting embodiment of an electrochemical method include the use of an iDES in a MP comprising of phosphoric acid, phosphonic acid or both with zinc chloride, zinc iodide, a transition metal halide, or a combination thereof, optionally with H₂O, wherein H₂S is used in the input material stream in a configuration akin to a phosphoric acid fuel cell where the phosphoric acid is at least partially replaced by the iDES. An additional non-limiting embodiment would use an iDES in conjunction with an electrolyte material comprising at least one of the following: SnₓIn₁₋ₓH_{y}P_{z}O_{ð}, CsHₓPO_{ð}, ZrₓH_{y}P_{z}O_{ð}, Nafion, PBI, PPI, PVP and PES, or a combination thereof as well as the aforementioned metals, catalysts, dopants or combinations thereof. Additionally, polymeric electrolytes such as those doped (e.g. PBI) with H_{y}P_{z}O_{ð}, or the former mentioned acids as well as EDTMP, oxide particles, cross-linkers such as TAB (diaminobenzidine), DHTA (dihydroxy- terephthalic acid) and TMA (trimesic acid)^{[Zhang et al., 2024]} can achieve high power density with reduced poisoning of the cell and could be further doped with iDES (e.g. iodine and bromide containing DES) to enhance conductivity, activity, or both. Furthermore other iDES could be used such as those mentioned in throughout this disclosure. HI, HBr, or generalizing a hydrogen halide could be formed and might need further electrolysis, thermolysis or both in order to produce hydrogen, such as through the envisioned cation conductor, dynamic cavitation, a heating element (not shown) or a combination thereof. Further non-limiting embodiments include the dynamic cavitation of the iDES, which beyond producing ions, radicals, or H₂O, could produce light which is further capitalized by the use of photocatalysts, plasmonic catalysts or both. It is noteworthy to state that diverse molten salts, iDES, and supercritical fluids are transparent or translucent in the optical range, some extending to regions in the ultraviolet and infrared, hence this method does not only rely on external photonic stimulus but can capitalize on internally gencrated photonic stimulus as well. Additional use cases involve the use of (coated) hydride-imides in order to promote the formation of ammonia, ammonium phosphates, or ammonium metal phosphates, which could later be dissociated to release ammonia.

A non-limiting embodiment includes the use an iDES consisting of phosophoric acid, phosphonic acid or both; at least one component selected from the following group ZnI_{ð}, ZnCl_{ð}, a transition metal halide, an alkali halide, an alkaline carth metal halide, ammonium halides, or a combination thereof; and H₂O. For example an iDES consisting of phosophoric acid: ZnCl_{ð} (and optionally H₂O) or phosphoric acid: ZnI_{ð} (and optionally H₂O) is used to promote the hydrolysis of H₂S. Other transition metals halides for iDES with the phosphorous based acids and other acids described below (optionally with H₂O) include VCl_{ð}, FeCl_{ð}, CoCl_{ð}, SnCl_{ð}, VI_{ð}, FeI_{ð}, CoI_{ð}, SnI_{ð}, and VBr_{ð}, FeBr_{ð}, CoBr_{ð}, SnBr_{ð}, ZnBr_{ð}; wherein the hydrolysis of H₂S can be promoted by at least one of the following mechanisms selected from the group consisting of: entropy of mixing, electrolysis, dynamic cavitation, photocatalysis, plasmonic catalysis, photocatalysis as produced a stimulus derived (dynamic) cavitation, plasmonic catalysis as a stimulus derived from (dynamic) cavitation or a combination thereof. Pending on the composition of the iDES elemental sulfur could be produced, that being said with H₂O and H₂O₂ further oxides, and sulfur containing acids are achievable. Solubilizers for sulfur and sulfur related compounds are considered within the scope of these embodiments, particularly as dopants for iDES, as entropy of mixing enhancers, or both these materials are including: ethylene glycol, PEG, cthylene oxide, PEO, polyethylene dimethyl ether, polyethylene monomethyl ether, polypropylene dimethyl ether, polypropylene monomethyl cther, propylene glycol, PPG, ethoxylates, alcohol ethoxylates, poloxamers, or combination thereof to name a few.

Further non-limiting examples of iDES include the use of HₓV_{y}O_{z} (vanadic acid and vanadates are also included for the case of x=0), M_{w}HₓV_{y}O_{z}, MᵥN_{w}HₓV_{y}O_{z} or a combination thereof (optionally with HₓP_{y}O_{z}, M_{w}HₓP_{y}O_{z}, or MᵥN_{w}HₓP_{y}O_{z} or a combination thereof) in combination with at least one component from the transition metal halides, alkali halides, alkali carth metal halides, H₂O, H₂O₂ or a combination thereof. HₓV_{y}O_{z} and HₓP_{y}O_{z} as well as related compounds have similar trends in forming polymeric chains as well as iDES, and hence here we propose them for further catalytic iDES, with a difference in the vanadium iDES have a lower bond strength due to the lower clectronegativity in comparison to phosphorous and various oxidation states (e.g. redox capabilities). That being said vanadium based iDES open a variety of applications particularly since vanadium compounds are used for industrial processes such as the Claus process, just as phosphates and phosphorous based iDES are used for desulfurization. Yet also vanadium containing iDES arc expected to have further applications for biomass processing, such as those not only for energy generation, pyrolysis, charring, and carbonization but also for deoxygenation (e.g. applying the oxide extracting layer) and carbon based product development. Further extending the previous range of non-reported iDES includes the use of molybdates, tungstates, borates, the acids thereof (e.g. boric acid) and generalizing to MᵥN_{w}HₓMo_{y}O_{ð}, MᵥN_{w}HₓW_{y}O_{ð}, MᵥN_{w}HₓB_{y}O_{ð}.

A non-limiting embodiment considers the following material space for achieving low melting point MP (e.g. up to 350° C.): Sn halides+Bi halides+Zn halides+(NH₄)ₓH_{y}PO_{z}+oxides+carbonyls+carbonates+carbides+iDES+(optionally H₂O); wherein the halides include at least one of Cl, Br, I or F anions; oxides include at least one of vanadates, bismuth oxides, or tin oxides; carbonyl includes at least one of: Ir(CO)ₓO_{y}, Ru(CO)ₓI_{y}, Rh(CO)ₓI_{y}, or Os(CO)ₓI_{y}; carbonates include at least one of: La₂Oₓ(CO₃)_{y}, Ce₂Oₓ(CO3)_{y}, CaCO₃, SrCO₃, BaCO₃, Na₂CO₃, K₂CO₃, or Li₂CO₃; and carbides include at least one of: VₓC, TiₓC, or the aforementioned adsorbants. When used in the oxidation MP, CH₄ can be deprotonated in the reducing MP, protons conducted through the electrolyte and then further conducted through the low melting point. Alternatively these can be used to reform biomass. Some of the sub-components such as ZnI and H₃PO₄, or ZnCl and H₃PO₄ form iDES which can weaken or stretch the OH bonds serving as hydrogen bond clippers and are widely available and cost-effective. This facilitates the processing of biomass in with widely available green chemicals. Which could now be facilitated to be deprotonated, produce bio-char, bio-oils or carbonize, as well as to generate electricity, akin to a direct methanol PEM, yet with an iDES doped electrolyte (nafion, PBI, etc. . . . ). Continuing on the applications for the reaction involving CH₄+CO₂→C+H₂O+H₂+CO→2C+2H₂O, whose intermediate step has a Gibbs free energy of −167 kJ/mol and an enthalpy of −213 kJ/mol. The intermediate step could proceed spontancously through an electrolyte nevertheless the complete reaction would likely require a further stimulus given the remaining free energy, such as those generated through dynamic cavitation and the aforementioned plasmonic catalysts or further driven through electrolysis. That being said the intermediate step could well be used for a plurality processes, such as for the formation of acetic acid with an overall formula of CH₄+CO₂→CH₃COOH. A non-limiting embodiment considers the use of the aforementioned iDES which could insert I ions, during cavitation/electrolysis to produce CH₃I from CH₃*, this is hypothesized could be further reacted with the reduced CO from the previous reaction (or potentially dynamically cavitated/electrolyzed CO₂) involving the carbonyls (primarily), the carbonates, and the carbides (particularly MXene derived).

A non-limiting embodiment considers the use of low temperature melting alloys as electrodes for polymeric electrochemical cells (also extending to other mentioned electrochemical cells) e.g. while using hydrogen, an alcohols, or hydrocarbons as fuel. The liquid metals or alloys include Ga, GaₓIn_{y}Sn_{z}, GaᵥIn_{w}SnₓBi_{y}Zn_{z}, AgₓGa_{y}, Ag_{w}GaₓIn_{y}Sn_{z}, BiₓPb_{y}Cd_{z}, BiₓPb_{y}Sn_{z}, BiₓIn_{y}Sn_{z}, and for completeness Hg, to name a few. These alloys can be further doped with a plurality of catalysts (including the aforementioned metallic, oxides, nitrides, to name a few) and HEA, such as the above mentioned. Particularly those that have a relatively high protonic conductivity or hydrogen permeability such as those based in Ga and Ga alloys. Additionally liquid Ag and alloys can solubilize oxygen further extending the ORR regions. This concept extends the electrode area to electrode volumes facilitating sluggish reactions by extending from a 2D sites to volumetric sites. Furthermore these electrodes exhibit lower poisoning effects for COₓ and C. While in the case of poisoning these could be easily regenerated or renewed ex-situ or in-situ. A final benefit include that at the end of life of the electrochemical cell, the metals are easier to be recycled.

A further non-limiting embodiment involves the use of a chemical potential e.g. entropy of mixing, or electrochemical potential as orthogonal potentials in order to lower the temperature of a reaction. The dry pyrolysis of methane is an endothermic process usually observed above 400° C. That being said, by the concomitant application of an induced voltage which one could loosely relate to a promotion of fermi level of about a few tens or hundreds of meV (as in semiconductors) which equates to a similar effect created by an increase in temperature. An open voltage produced by a fuel cell ranges could convey an electron about 1.1 eV in ideal cases to 0.4 eV. Hence a lower temperature is likely to catalyze the pyrolysis reaction when applying a chemical or electrochemical potential. Thus by leveraging a composite MEA one can capitalize on current produced when oxidizing protons and recycle it to further promote the catalysis of methane by creating a subsequent electrical/chemical potential. An example could be observed in shockwave electrodialysis where an electrically polarized grit (by the way Aramco [Ia hra] didn't include grits in my previous patent [maming it as well] for shockwave electrodialysis technology for oilfield e-chemicals, even though it was in the invention disclosure form; also KAUST for editing my clip and hiding part of Q&A on golden/natural hydrogen on what was supposed to be an open research information forum, who would know someone could make good questions which could be considered as national priority on the spot [and projects as well]), given that methyl radicals tend to be positive a tandem use of a proton conductor and a subsequent proton conductor (or an oxide extraction layer). In such embodiment it is expected to segregate charged protonic or methyl species at different speeds from neutral species such as carbon, akin to electrophoresis. It is to be noted that grit placement is paramount to have carbon particles smaller than the grit porosity.

A non-limiting embodiment would include the use solubilizing agents, adsorbents, absorbents or molecular sieves including vanadium carbide, titanium carbide (e.g. MXene), Osmium or a combination thereof in order to solubilize methane, hydrocarbons or hydrogen sulfide in an MP comprised by at least one of the group consisting of the aforementioned: molten salts, H_{y}P_{z}O_{ð}, iDES, liquid metals or a combination thereof in order to enhance the contact area, reaction volume, solution homogeneity, decrease bubble size, or a combination thereof. Additional solubilizing agents, adsorbents, absorbents that could be incorporated for nitrogen catalysis (e.g. to produce ammonia, ammonium compounds, carbon nitrides or doped nitrides) include at least one of the following materials selected from the group consisting of: BaₓH, SrₓH, BaₓN_{y}H_{z}, Mn_{w}NₓBa_{y}H_{z}, NiₓBa_{y}H_{z}, NiᵤCoᵥMn_{w}NₓBa_{y}H_{z}, MoᵤCoᵥMn_{w}NₓBa_{y}H_{z}, FeᵥMn_{w}NₓBa_{y}H_{z}, LaₓN_{y}H_{z}, LiₓN_{y}H_{z}, CaₓN_{y}H_{z}, VN_{y}H_{z}, TiN_{y}H_{z}, MoᵤCoᵥMn_{w}NₓK_{y}H_{z}, MoᵤCoᵥMn_{w}NₓNa_{y}H_{z}, FeᵥMn_{w}NₓK_{y}H_{z}, FeᵥMn_{w}NₓNa_{y}H_{z}, the aforementioned coated by a carbon allotrope, or a combination thereof.

Furthermore the use of these materials or MP can create a synergy with dynamic cavitation in order to facilitate a reaction given the linear adsorption relation on these materials with pressure.

A non-limiting embodiment includes the use of alloys of metals or a solution of metals and metal oxides as an oxygen electrode. One of the limiting steps for most FCs is the oxygen reduction reaction (ORR). By tailoring an alloy to include a mixture of metals wherein one is more relatively stable towards oxidation (e.g. Ag, Os, Ga, Sn, Pb) than another metal or metal oxide component (e.g. Bi, V, Ce), wherein the Gibbs free energy between stoichiometries of the metal oxide is smaller than that of H₂O (e.g. at STP: Pb and PbO Gibbs free energy difference is −189 KJ/mol or Bi₂O₃ and Bi₂O₅ Gibbs free energy difference is about 55 KJ/mol, other examples could include Ce, Mn, V, Pr, Tb, Nd, Eu, Sb, Dy, and Tl) could comprise a liquid oxygen carrier for electrochemical processes. Furthermore alloys wherein the most stable stoichiometry of a components metal oxide is an oxide with less oxygen component (e.g. ZnO and ZnO₂ Gibbs free energy is −320 kJ/mol and −242 kJ/mol, respectively) would also serve as an effective oxidizer for an oxidation reaction. That being said these chemicals are often prepared by the oxidation with H₂O₂, nevertheless it could also be promoted through the dynamic cavitation at interfacial layers. Furthermore by using a liquid metal alloy (effectively a multiphase fluid) as an oxygen carrier the area of the rate limiting step can be extended to the area of the interface between the MP and oxygen/air or in some cases throughout the volume of the MP. An example of the latter include MP composed of nanofluids.

In a non-limiting embodiment an oxygen electrode in contact with a cation conductor, hydride conductor or oxide extracting layer is composed of an electrically conductive phase (liquid, solid, or both) and at least one of the following materials selected from the group of: a molten carbonate phase, a molten vanadate, a molten nitrate phase, a molten nitrite phase, a molten halide, a molten molybdate, a molten tungstate, or a combination thereof (e.g. to lower the melting point). The electrically conductive phase could be solid, liquid, or both, also including low melting metals or low melting alloys (e.g. with Ag, which exhibits high volumetric oxygen intake in liquid state). The molten carbonates incorporates oxygen as ions (e.g. the superoxide O₂⁻, peroxide O₂²⁻ in addition to carbonate ions) effectively facilitating the ORR not only in close proximity with the electrolyte and thus facilitating the reaction with cations, such as protons, from the electrolyte. This effectively extends the ORR from the surface of the oxygen electrode to the volume of the oxygen MP. Low melting alloys can be selected from metals whose carbonates decompose above a certain temperatures such as Sn, Sb, Bi, Zn, Ga, Mg, Ni, Pt, and Pb to mention a few, wherein the decomposition temperature is comparable to the operation temperature. As well as those with a low Gibbs free energy for reduction such as Ag or Os. This is a selection criteria so that the molten metals do not carbonate and are easily reverted to the metallic state upon oxidation. Additional inclusions to a carbonate mixture include nitrates, nitrites or halides in order to lower the melting temperature of the mixture. Nitrates and nitrites pairs have the functionality to work as oxygen carriers. Further optional elements that can be included extended to oxides with diverse stoichiometrics. Expanding on a previous non-limiting embodiment, these oxides which higher oxides can be synthesized in air or pure oxygen (depending on input stream) and temperatures, are more likely to oxidize than the liquid metal given the difference in the Gibbs free energy, yet the difference between stoichiometries is still less than the energy of formation of H₂O. Examples include BaOₓ, NaOₓ, LiOₓ, CoOₓ, as well as the commonly known oxygen conductors for SOFCs electrolytes (e.g. GDC, SDC, EDBi, to name a few) and cathodes (e.g. BSCF, BiSCO, LSCF, PBSCF, PBC, SSC, PrNiO, LaNiO, and BiRuO, to name a few). That being said this analysis could be extended for CO formation for liquid anode with an oxygen extracting ionic layers (or even for CO₂ energy of formation, although that is not the prefered scope of this disclosure's author due to GHGs yet it is considered within the scope for completeness). In a further non-limiting embodiment the oxygen electrode is composed of a liquid metal or liquid alloy further comprised of nanoparticles or 2D materials (e.g. MXenes, V₂C). Further extending the previously mentioned non-limiting embodiments a carbonate containing oxygen electrode could further include the use of alkali nitrites, metal nitrates, nitrites thereof, diphenyl carbonate, ethyl phenyl carbonate, alkyl phenyl carbonates, ethylene carbonates, methyl carbonate, propylene carbonate, metal halides or a combination thereof. These materials have a lower melting temperature enabling lower operating temperatures beyond the concomitant use of molten metals. The organic carbonates are chosen based on the like dissolves like principle.

Furthermore some of these contribute to catalytic properties. The use of oxygen MP can further have an application to create a nitrogen rich and oxygen lean material stream, which could be employed in a plurality of applications including nitrogen fixation for ammonia production, or as a relatively inert gas blanket, to name a few.

A further non-limiting embodiment includes the use of low melting point metals and eutectics mixtures involving one or more of: Bi, Sn, Sb, Ag, Ga, or Zn with catalysts such as Mo, Ni, Co, as well as the aforementioned high entropy alloys or catalysts. The use of low melting metals facilitates the startup of the process as well as it enables a wider operating temperature window. Furthermore it enables the use of materials which have sufficient conductivity in that range including but not limited to SmₓNi_{y}O_{ð} (and composites of SmₓNi_{y}O_{ð} to enhance proton selectivity), SnₓIn_{y}PO_{ð}, HₓMo_{y}O_{ð}, HₓW_{y}O_{ð}, HₓSr_{y}Co_{z}O_{ð}, CsHPO_{ð}, CePO_{ð}, ZrPO_{ð}, BaₓIn_{y}O_{ð}, BaᵤZrᵥCe_{w}YₓYb_{y}Zn_{z}O_{ð}, Ba_{w}InₓAl_{y}Zr_{z}O_{ð}, Sr_{y}Fe_{z}O_{ð}, HₓMo_{y}O_{ð}, HₓW_{y}O_{ð}, HₓSr_{y}Co_{z}O_{ð}, composites with Pd-alloys (to enhance the overall conductivity selectivity towards hydrogen and facilitate catalysis e.g. CO₂ to formic acid); as well as the synthesis of materials which are thermodynamically favourable (e.g. ammonia) between 150° C. and 500° C. On top of these an optional eutectic salt layer of involving at least two of: NaI, KI, LiI or LiVO₃, KBr, KVO₃, Li₂MoO₄, LiF, or K₂MoO₄. An optional further layer consists of the aforementioned high temperature silicon-based oils, perfluoroether oils (for higher temperatures) or related high temperature high temperature oils atop. The high temperature oils arc intended at least to be used as an optional layer in order to purify the products from residuals (e.g. as they are pushed up by the denser layers or in separate containers) as well as to limit oxygen diffusion into denser layers. This layer is kept far enough from high temperatures to prevent its degradation, and it could also be circulated within or without the reactor. Further layers could include aqueous or organic solvents atop, including the same hydrocarbon input stream. Using some of the aforementioned electrolytes, in order to produce carbon and water from hydrocarbons such as methane. Methane is used as the reference due to its thermal and kinetic stability, where further hydrocarbons or plastics would be less stable and thus easier to react. Further enhancement includes the use of the aforementioned (coated) hydrides, imides, or both for the reduction at room temperature of nitrogen in order to produce ammonia, which for select hydrocarbons the reaction is still favourable below 500° C. as well as and other nitrogen containing compounds. The use of adsorbants, such as the aforementioned carbides (e.g. extending MXene prepared) and others, is to facilitate the incorporation of methane to the MP and increase the throughput of the reaction. There are several perspectives to it, the initial is to increase the contact area from a methane bubble to the area of the nanoparticles or microparticles, furthermore most of the mentioned adsorbants have their own intrinsic catalytic properties. Additionally these can make nanofluids which increase solubility of the overall fluid as well as thermal conductivity. As mentioned earlier the embodiment could further include a vortex diode, a Venturi injector or both.

In a further non-limiting embodiment there is no fluid material output so that produced material output steam is conducted through an ionic layer.

In an additional non-limiting embodiment an MP can be: oxidation, nitridation, reduction, infusion, adhesion, anchoring (e.g. through capillary forces), diffusion, physically plugging, and/or held in order to seal, plug or amend imperfections in the electrolyte or ionic conductor (e.g. cracks or leaks) in the ionic conductor in order to reduce, avoid or both of at least one of the following items selected from a group consisting of: device failure, catastrophic failure, device performance degradation, electrical shorting, material streams mixing through the ionic conductor or a combination thereof. A major (safety) concern in mobile applications, particularly in the case for non-polymeric based electrolytes than polymeric ones, is that vibrations could induce cracks or leaks in an ionic conductor. An non-limiting example might include oxidizing metal, semi-metal, semiconductor (e.g. including but not limiting to zinc, lithium, Mn, Mg, Sn, Sb, Bi, Si, or Ti, to name a few) containing MP upon exposure to the oxidizing environment of the oxygen electrode or oxygen MP. Alternatively the pressure of an oxygen MP could be slightly increased in order to seal, plug, or amend the imperfection in the ionic conductor. This non-limiting embodiment can take place during the operation of an electrochemical device. Furthermore, the safety measure can be only a temporary measure, such that the device can be further amended thereafter.

A non-limiting embodiment includes releasing ammonium during dynamic cavitation an example of such would include cavitating an ammonium (metal) phosphates, ammonium (metal) vanadate, or a nitride-hydride such as NiᵤCoᵥMn_{w}NₓBa_{y}H_{z}, ammonium tungstate, ammonium molybdate, ammonium vanadate, ammonium tin phosphate, or ammonium phosphomolybdate. A further non-limiting embodiment includes releasing adsorbed or chemically bonded sulfur atoms such as when using a phosphoric acid MP or iDES in conjunction with a photocatalytic sulfide such as MoSₓ, Au_{z}Li_{y}S_{z}, VₓCu_{y}S_{z}, or CuᵥZnₓSn_{y}S_{z}. A further non-limiting embodiment involves releasing oxygen from COₓ by dynamically cavitating Ga, an amide group containing solvent (e.g. DMF), and COₓ, with a further catalyst (e.g. silver fluoride, a liquid metal containing Ag or Os, BaO_{ð}, a liquid oxygen carrier, or a liquid oxygen ion carrier), which by using dynamic cavitation one would reduce the energy input required to induce a triboelectric effect (e.g. in comparison to ultrasonication) or incorporate oxygen, facilitating the process scale up, furthermore by mixing using a Venturi the surface area available for reaction increases.

As a non-limiting embodiment, some of the aforementioned materials can exsolve metallic

nanoparticles (e.g. including nickel, cobalt, iron, Mn, copper, platinum, palladium, or Au, to name a few). The nanoparticles can be further reacted to produce an oxide, a nitride, a carbide, a sulfide, a phosphide, or a combination thereof. These exsolved nanoparticles exhibit a higher interaction with the host material and exhibit: higher catalytic effects, higher poisoning resistance or both.

It is envisioned within the scope of this invention that a synergy between the diverse orthogonal energy stimuli can provide diverse advantages from the material selection as well as the process and/or device design perspective. Thermal limitations of the aforementioned considerations are generally related to diffusion, melting, or evaporation of a component or subcomponent. It is envisionable for those skilled in the art that materials diffusion and reaction are generally dependent on each other, yet in-situ or ex-situ application of at least one of the following: an electric field, a magnetic field, an electromagnetic field (e.g. UV-Vis-IR or microwave), a plasmon, a plasma (e.g. thermal or non-thermal), a chemical potential, ultrasound, and a combination thereof, to name a few, can promote a reaction without significantly altering the diffusion or degradation of a material in relation to the required thermal energy to achieve similar yields.

In the case of plasmonic materials it is theorized that the oscillating nature of the created electric fields can temporarily align the band structures as to promote a reaction as if the chosen materials were in proper band alignment as well as hot electrons could promote reactions not typically available at given overall material temperature. Notable high temperature reactions involve the reaction between nitrogen and hydrogen to form NH₃, nitrogen and oxygen to form NOₓ, COₓ dissociation or a combination thereof. Furthermore the photonic degradation of a material can induce vacancies in the anion carrier. These phenomena are conventionally termed as photo-bleaching or photo-corrosion, yet from the carrier material perspective it can be appreciated as the regeneration of the material. Hence anybody of ordinary skill in the art could envision without departing from the scope of this disclosure that a highly photo-corroding carbide or sulfide material would be beneficial for the catalysis or release of carried atom or in a continuous type of process where the overall content of the carried atom in the material may be stabilized by the equilibrium of the photo- corrosion or vacancy creation with the concomitant occupation of vacancies with reactants (e.g. hydrocarbons, plastics, or H₂S).

Furthermore it could be appreciated by those skilled in the art that a continuous process could be envisioned, particularly when operating near the thermodynamic inflection point from changing from a thermodynamically and/or kinctically preferred state to another such that the orthogonal energy input could promote a given reaction with a reduced thermal budget. Such reduced operational temperature window could reduce the energy expenditure of the overall process ensuing higher sustainability and economic benefits.

### Areas of Applicability and Utility of the Invention (Non- Limiting, Non-Comprehensive)

The advantages of producing organic matter which does not represent a contaminating gas emission has a plurality of use cases. The following examples does not comprehend an exhaustive list of applications and hence does not seek to limit the scope of usability of the current disclosure. In brief this disclosure applies for static and mobile uses, whether for maritime, terrestrial, aerospace or extraterrestrial.

The O&G industry utilizes hydrogen in the fuel refining processes. As mentioned earlier SMR is a conventionally used hydrogen production route. These processes could decarbonize its emissions as well as to alleviate the hydric stress, particularly for desertic areas where water is a highly valued commodity and soil (sands) are organic matter (carbon) deficient. Furthermore, current decarbonization trends particularly on energy decarbonization creates a trend to reduce the value of hydrocarbons reserves. Gas networks could upgrade their streams of natural gas or LNG to hydrogen enriched gas and thus reduce the carbon footprint of their products through-out their life cycle. Additionally for niche markets where domestic applications are utilizing FCs for distributed domestic combined heat and power, serving as a redundancy for areas where there is intermittency in the electrical energy supply.

The plastics market is constantly producing waste it was estimated that less than 10% is actually recycled.^{[OECD, 2022]} This waste is primarily sent into landfills (50%), incinerated (˜20%) or dumped. Polystyrene (PS) is a type of plastic that is non-trivial to be recycled cost-effectively. PS, polyethylene (PE; low density, high density, or ultra high molecular weight) and polypropylene consist primarily of carbon and hydrogen with additives. It is estimated that between 400 million and 500 million tons of plastics are produced of which it is estimated that about half of it is comprised of PE, PS, or PP. These plastics poses a melting temperature below 280° C. and an energy density comparable to traditional liquid or gaseous fuels. Rather than being incinerated to only release heat, green house gases, and other toxic gases, I disclose yet another alternative to produce clean energy, energy vectors, and/or carbon.

Waste plastics are actually traded and routinely shipped between countries by sea. The ships are being propelled by oils such as heavy fuel oils. With the proposed process, plastics and hydrocarbons can be used as organic hydrogen carriers (OHC). These OHC could be used to propel maritime vessels as well as to provide unsalted water. Furthermore this process could easily envision to power electrical plants cleaning the emissions of burning coal or low grade oils, while doubling down as a clean on-board water/steam source. Additionally, the produced carbon is less likely to end up as microplastics at sea with this method.

These are not the only types of vehicles that could benefit from the reduced carbon emissions of this process. Land vehicles (including: automobiles, trucks, tractors) can benefit from the reduced carbon emissions process and its fuel flexibility, particularly when paired with a capacitor or battery system. This would effectively circumvent the CAPEX investment to repurpose hydrocarbon dispensaries (gas stations), infrastructure and primary logistics; while simultaneously alleviating the range anxiety of battery powered electric vehicles or hydrogen powered vehicles in a flex fuel route. Carbon residuals could be discarded at conventional fueling stations and centralized using the return logistics of the same hydrocarbon (OHC) tanks (pipes) to loading locations.

Aircrafts are utilizing FCs to produce onboard electricity. The aviation industry is keen on offsetting carbon emissions, e.g. such as by using bio-fuels or e-fuels. A design parameter is the aviation fuel energy density by weight and volume. This disclosure has an application benefiting aircrafts by decarbonizing emissions, particularly when considering propeller and rotor based vehicles as well as for hydrogen powered turbines. As a side note, by using bio-fuels or e-fuels, an overall cycle assessment would indicate a positive carbon sequestration. When considering this methods for onboard electrical energy the co-produced H₂O could further be used on board, which would further reduce weight and costs. Moreover, recent trends on electric aerial vehicles include VTOLs (vertical take off and landing). The e-VTOLS are range limited by battery charge density, charging time, weight, and onboard space. This disclosure would further alleviate these limitations since it can produce a similar energy density to conventional hydrocarbons.

This disclosure has the potential to produce carbon negative electrical energy or energy vectors through the use of biomass, bio-gas, or bio-fuels. This is conceptually simple use since the sequestered carbon would not be reemitted to the atmosphere, particularly for remote areas where the produced bio-fuel is consumed onsite. Bio-energy vectors also contain oxygen and could produce carbon containing gaseous emissions. Nevertheless a LCA could further elucidate on this application's carbon intensity, particularly when a proton conductor is paired with a oxygen conductor. Other benefits could include the decentralized production of ammonia and nitrates.

Aerospace and outer space applications have further applications for the disclosed methods. A non-limiting example is the CO₂ free or reduced COₓ reforming of CH₄ to carbon and water. CH₄ is already used as a propellant and its reforming avoiding COₓ would reduce consumption of stored oxygen. Furthermore when CO₂ is processed e.g. with a Ga containing metal and triboelectric nanoparticles such as AgX, rather than being ultrasonically activated, which requires higher (clectrical) energy consumption. The cavitation including CO₂ could be induced dynamically or mechanically, producing at least oxygen at relatively low temperatures. A particular use case would relate to the martian atmosphere, where CO₂ is one of the primary components.

Further industrial applications pertain to the synthesis of diverse (doped/undoped) carbon allotropes or carbon nitrides having a higher commercial value relative to graphite. These include the production of diamonds, diamond seeds, buckyballs, graphene, diamond-like materials whether in the nano, micro, or macroscale, catalysts, seed layers, or templates of materials like boron nitride (BₓN_{y}), silicon, germanium, III-V semiconductors (GaAs) could be used to tailor a specific allotrope of carbon.

Another underutilized energy source is H₂S. This gas is produced in the kilotons per day range globally and it is expected to increase as the world taps further into sour gas wells. The clemental sulfur produced is on the 10 s of cents per kg range while the hydrogen which is not energetically used is in the USD per kg. Hence the mentioned phosphate based solutions would provide a further waste to clean energy solution.

Throughout the application ordinal numbers (for example, first, second, third) may be used as an adjective for an element (that is, any noun in the application). The use of ordinal numbers does not imply or create a particular ordering of the elements or limit any element to being only a single element unless expressly disclosed, such as by the use of the terms “before,” “after,” “single,” and other such terminology. The use of ordinal numbers is to distinguish between the elements. By way of an example, a first element is distinct from a second element and the first element may encompass more than one element and succeed (or precede) the second element in an ordering of elements.

Throughout the application subscripts represent values which range between −1.00 and 5.00 and include −1.00 and 5.00. Non-limiting examples of subscripts utilized within this application include u, v, w, x, y, z, α, β, γ, Δ, ε, ð or Ð.

It is to be understood that the singular forms “a,” “an,” and “the” include plural referents unless the context clearly dictates otherwise. Thus, for example, reference to “an active catalyst” includes references to one or more of such catalyst, or a “material stream” includes references to one or more of such material stream.

It is to be understood that when a reduction of a characteristic or trait is stated the total avoidance of such characteristic or trait is included. Thus, for example, reference to “reduce CO₂ emissions” includes to avoid CO₂ emissions.

Terms such as “approximately” or “substantially” mean that the recited characteristic, parameter, or value need not be achieved exactly, but that deviation or variations, including, for example, tolerances, measurement error, measurement accuracy limitations and other factors known to those skilled in the art, may occur in amounts that do not preclude the effect the characteristic was intended to provide.

Where a range of values is provided, it is understood that each intervening value, to the millionth of the unit of the lower limit (unless the context clearly dictates otherwise), between the upper and lower limit of the range, and any other stated range. Where the stated range includes one or both of the limits, ranges excluding either or both of those included limits are also included in the disclosure.

It is to be understood that one ore more of the steps shown in the flowcharts may be omitted, repeated or performed in a different order than shown. Accordingly, the scope disclosed should not be considered limited to the specific arrangement of the steps shown in the flowcharts.

Although multiple dependent claims are not introduced, it would be apparent to one of skill in the art that the subject matter of the dependent claims of one or more embodiments may be combined with other dependent claims without departing from the scope or spirit of the present disclosure.

Within the skill of the art are to be included, unless otherwise indicated, techniques of physics, chemistry, engineering, catalysis, material science & engineering, analysis & quantification, economics, and the like. Such techniques are fully explained in the literature.

Although only a few example embodiments have been described in detail above those skilled in the art will readily appreciate that many modifications are possible in the example embodiments without materially departing from this invention. Accordingly, all such modifications are intended to be included within the scope of this disclosure as a defined in the following claims.

The invention claimed is:

1. A method for reacting electrochemically, chemically, or both at least one first material stream to produce at least one output material stream by at least one of the means selected from the group consisiting of:
contacting the first material stream with at least one first electrode, wherein the first electrode is a liquid, a multiphasic fluid, or both, wherein the first electrode is in contact with a first cation conducting layer or a first hydride ion conducting layer, and the first cation or hydride conducting layer is in contact with a first counter electrode; contacting the first material stream with at least one first electrode, wherein the first electrode is a liquid, a multiphasic fluid, or both, and wherein the first electrode is in contact with a first oxide ion extracting layer or a first hydroxide conducting layer, and the first oxide ion extracting layer or first hydroxide conducting layer is in contact with a first counter electrode; at least one of the aforementioned wherein the first counter electrode is in contact with a second material stream and the first counter electrode is a solid, liquid, or multiphasic fluid and the electrolyte is a solid or at least partially a solid; dynamically cavitating a material stream, wherein at least one of the following material streams selected from the group consisting of: a first material stream, a second material stream, an output material stream, or a combination thereof in a liquid or a multiphasic fluid; contacting a material stream by means of the Venturi effect in a liquid or multiphasic fluid; mixing at least one liquid, multiphasic fluid, or a combination thereof by the means of the Venturi effect; or a combination thereof;
wherein at least one of the aforementioned liquid or multiphasic fluid consists of at least one material selected from the group consisting of: a liquid metal, a liquid salt, an inorganic deep eutectic solvent, a partially inorganic deep eutectic solvent, a supercritical fluid, a nanofluid consisting at least partially of at least one of the aforementioned liquids or multiphasic fluids, at least one of the aforementioned further consisting of H₂O, or a combination thereof.

2. A method of claim 1, wherein the method is intended for at least one application selected from the group consisiting of: produce electrical energy; produce thermal energy; reduce emissions of CO₂; reduce emissions of CO; reduce the molecular carbon content in gaseous emissions; catalyze a reaction; reduce the thermal energy input requirements for a reaction; reduce the electrical energy input requirements for a reaction; produce a fuel; produce a decarbonized fuel; increase the throughput of a reaction; reduce coking; reduce poisoning by CO₂, CO, or both; reduce sulfur poisoning; reduce molecular sulfur content in gaseous emissions; reduce sulfur deposition; reduce the average operating temperature without reducing the reaction yield; increase the number of reaction sites; extend the reaction sites from an interfacial area to a volume; increase the contact time; allow for non-destructive electrode regeneration; allow for external electrode regeneration; allow for electrode ionic layer interface performance regeneration; selectively oxidize an input material stream in order to reduce by 20% or more the emissions of CO₂, CO, or both in comparison to direct oxidation; generate heat for at least one of the following: a thermal cycle, a Rankine cycle, to generate steam or a combination thereof; electrochemically produce high pressure H₂O or all the material precursors in order to produce high pressure H₂O; produce energy with an overall positive carbon sequestration; the like; or a combination thereof.

3. The method of claim 1, stimulated by at least one input selected from the group consisting of: electrical potential, chemical potential, electrochemical potential, triboelectric potential, thermal, photonic, plasmonic, mechanical, density differential, or a combination thereof; wherein optionally at least one of the following input conditions is met selected from a group consisting of: a potential is between −1 kV to 1 kV, photon or plasmon energy is between 0 to 5 eV, speed between 0 and 100 m/s, density differential of 24 g/cm3.

4. A method of claim 3, wherein the interfacial tension of a liquid, a multiphasic fluid, or both, is reduced or increased by the means of at least one of the following procedures selected from the group consisting of:
applying an electical voltage, applying an electrical current, regulating the ionic current through an ionic conducting layer, regulating the voltage across an ionic conducting layer, inducing a thermoelectric potential, or a combination thereof.

5. A method of claim 3, wherein the product selectivity of an output material stream is tuned by regulating at least one of the following items selected from a group consisting of: applying an electical voltage, applying an electrical current, regulating the ionic current through an ionic conducting layer, regulating the voltage across an ionic conducting layer, inducing a thermoelectric potential, or a combination thereof.

6. A method of claim 1, wherein at least a first material stream, a second material stream or both contains at least one material selected from the group consisiting of: a hydrocarbon, a bio-sourced hydrocarbon, H₂S, SOₓ, COₓ, biomass, vegetable oil, plastics, recycled plastics, waste plastics, alcohols, nitrogen, hydrogen, oxygen, air, NOₓ, ammonia, bitumen, heavy oils, fly ash, vacuum, hydrogen peroxide, KOH, NaOH, H₂O, aldehydes, the like, or a combination thereof; and
at least one output material stream contains at least one material selected from the group consisting of: hydrogen, ammonia, a carbon allotrope, diamonds, carbon nitride, CₓN_{y}, CₓN_{y}H_{z}, CS₂, sulfur allotrope, aromatic hydrocarbons, linear hydrocarbons, carbon disulfide, a doped carbon allotrope, doped carbon nitride, hydrazine, water, steam, an alcohol, acetic acid, formic acid, a carboxylic acid, an organic hydrogen carrier, inorganic hydrogen carrier, oxygen, a metal nitrate, fuel, a decarbonized fuel, a desulfurized fuel, ammonium nitrate, SOₓ, H₂SOₓ, COₓ₋₁, the like or a combination thereof, wherein subscripts x,y,z are independent from a selected material to another selected material and range between 0 and 5 including all values between 0 and 5, 0, and 5, where physically applicable.

7. A method of claim 6, wherein the overall throughput of the output material stream or output material streams exceed the throughput of the output material stream or output material streams that were at least partially conducted through the ionic conducting layer.

8. A method of claim 6, wherein electricity, thermal energy, or both are co-produced with at least one output material stream.

9. A method of claim 8, wherein the production or consumption of electricity, thermal energy, or both is compensated, traded, or exchanged with the production of at least one material output stream in order to achieve at least one of the following outcomes selected from a group consisting of: reducing on/off cycles, balancing an electrical grid, compensate for fluctuating renewable energy production, balancing an electrical circuit, storing energy in a chemical energy vector, reduce downtime, store energy surplus, or a combination thereof.

10. A method of claim 8, wherein the method is used for static applications, mobile applications, or both.

11. A method of claim 10, wherein at least one material output stream is stored for subsequent use as at least one of the following: a means of producing energy, an input material stream, a means of distributing energy, or a combination thereof.

12. A method of claim 1, wherein the ion conducting layer is a composite layer in order to increase the selectivity towards a particular ion, reduce ionic resistance, or both.

13. A method of claim 1, wherein a liquid or a multiphase fluid is employed for reversibly bearing at least one of following species selected from the group consisting of: oxygen, oxygen containing ionic species, hydrogen, hydrogen containing ionic species, nitrogen, or a combination thereof, and consist of at least one material selected from the group of: a first liquid metal, a first molten salt, a first inorganic deep eutectic solvent, a first partially inorganic deep eutectic solvent, a first liquid alloy, first metal oxide, or a combination thereof, wherein the bearing liquid or multiphase fluid overall phase remains in a liquid or fluid form while in the bearing state; and optionally the energy difference between: the bearing and unloaded state of a component, sub-component, or both of the liquid or multiphase fluid is smaller than the energy of dissociation of H₂O or CO₂.

14. A method of claim 13, wherein the the liquid or the multiphase fluid is composed by at least one material selected from the group consisting of: Ag; Os; Sb; Sn; Pb; Zn; Cu; Ni; Ti; Mg; Mn; Sn; Bi; Co; Tl; Co; Ce; Sr; Li; Hg; SbₓSn_{y}; SnₓBi_{y}; SnₓPb_{y}; SbₓPb_{y}; MoₓNi_{y}Bi_{z}; Mo_{w}CoₓNi_{y}Bi_{z}MoₓNi_{y}Sb_{z}Sn_{ð}; Mo_{w}CoₓNi_{y}Sb_{z}Sn_{ð}; MoₓNi_{y}Bi_{z}Sn_{ð}; Mo_{w}CoₓNi_{y}Bi_{z}Sn_{ð}; MoₓNi_{y}Sb_{z}Pb_{ð}; Mo_{w}CoₓNi_{y}Sb_{z}Pb_{ð}; ZnₓSn_{y}Cu_{z}; ZnₓSn_{y}Ni_{z}; ZnₓSn_{y}In_{z}; SnₓBi_{y}In_{ð}; ZnᵤSnᵥInₓBi_{w}Ni_{y}Mo_{z}Cu_{ð}; at least one of the aforementioned further containing at least one or more materials selected from the group consisting of: Ba_{α}O_{ð}, V_{α}O_{ð}, Mn_{α}O_{ð}, Cu_{α}O_{ð}, Bi_{α}O_{ð}, Tl_{α}O_{ð}, OsO_{ð}, GeO_{ð}, SrO_{ð}, CaO_{ð}, SiO_{ð}, AlO_{ð}, TiO_{ð}, ZrO_{ð}, YₓZr_{y}O_{ð}, MgO_{ð}, Mg_{α}Al_{β}O_{ð}, NiO_{ð}, CeO_{ð}, V_{α}C_{β}, Ti_{α}C_{β}, Mo_{α}C_{β}, W_{α}C_{β}, Y_{α}C_{β}, Cr_{α}C_{β}, Hf_{α}C_{β}, Ba_{α}C_{β}, Sr_{α}C_{β}, Ca_{α}C_{β}, La_{α}C_{β}, Zr_{α}C_{β}, Ta_{α}C_{β}, Ce_{α}C_{β}, La_{α}C_{β}, Gd_{α}C_{β}, BN_{β}, Mn_{w}Nₓ, Ba_{y}H_{z}, NiₓH_{z}, MoₓCoᵥN_{z}, Ni_{α}MoᵤCoᵥMn_{w}NₓBa_{y}H_{z}, FeᵥMn_{w}NₓBa_{y}H_{z}, LaₓN_{y}H_{z}, LiₓN_{y}, CaₓN_{y}H_{z}, VN_{y}, TiN_{y}, MoᵤCoᵥMn_{w}NₓK_{y}H_{z}, MoᵤCoᵥMn_{w}NₓNa_{y}H_{z}, FeᵥMn_{w}NₓK_{y}H_{z}, FeᵥMn_{w}NₓNa_{y}H_{z}, at least one of the aforementioned coated in graphene, at least one of the aforementioned coated in a carbon allotrope, or a combination thereof; at least one anion selected from the group consisting of: carbonates, nitrates, molybdates, vanadates, phosphates, halides or a combination thereof, and at least one cation selected from the group consisting of: H, Li, Na, K, alkali metals, alkaline carth metals, Zn, Cu, Ni, Ti, Mg, Mn, Sn, Bi, transition metals, ammonium, or a combination thereof; a nanofluid thereof; ethylenediamine tetramethylene phosphonic acid; alkyldiamine tetraalkyl phosphonic acid; (NH₄)ₓVO_{y}PO_{ð}; phosphomolybdic acid; phosphotungstic acid; H₂O₂; or a combination thereof;
wherein subscripts u, v, w, x, y, z, α, β, and ð are independent from a selected material to another selected material and range between 0 and 5 including all values between 0 and 5, 0, and 5, where physically applicable.

15. A method of claim 1, wherein the multiphasic fluid consists of at least two phases selected from the group consisting of: a first solid phase, a first liquid phase, a first gaseous phase, a first fluid phase, a first nanofluid phase, a first ion conductive phase, a first electrically conductive phase, a first at least partially stratified phase, a first catalytic phase, a first particulate phase, a first atomic carrier phase, a first molecular carrier phase, a first transparent phase, a first electromagnetic waveguide phase, a first plasmonic phase, a first adsorbent phase, a first absorbent phase, a first molecular sieving phase, a first supercritical fluid phase, a first semiconducting phase, a first insulating phase, a first triboelectric phase, a second triboelectric phase, a first emulsified phase, a phase combining properties of at least more than one of the aforementioned phases, a phase mixing at least two of the aforementioned phases, the like, or a combination thereof.

16. A method of 1, wherein at least one of the following: the dynamic cavitation, the injection, the mixing, ejection, or a combination thereof, is performed by at least one device selected from the group consisting of:
a Venturi effect inducing device, a vortex diode, a Helmholtz, resonator, a rotor-stator, a Bernoulli device, a Coanda device, gears, a cyclone, a screw pump, an electromagnetic radiation device, the like, or a combination thereof.

17. A method of claim 1, wherein the method involves the use of at least one of the following materials selected from the group or sub-groups consisting of: ZnCl_{ð}; ZnI_{ð}; ZnBr_{ð}; chloride salts; CuCl_{ð}; MoCl_{ð}; CoCl_{ð}; BiCl_{ð}; NiCl_{ð}; PCl_{ð}; LiCl; LiF; FeCl_{ð}; alkali halides; metal halides; (NH_{w})ₓP_{y}O_{ð}; (NH_{w})ₓM_{y}P_{z}O_{ð}; SnₓIn₁₋ₓH_{y}P_{z}O_{ð}; CsHₓPO_{ð}; ZrₓH_{y}P_{z}O_{ð}; phosphates, pyrophosphates; phosphorous containing acids; HₓPO_{ð}; SnₓIn_{y}PO_{α}Cl_{ð}; HₓV_{z}O_{ð}; HₓM_{y}V_{z}O_{ð}; at least one material selected from the group consisting of: HₓPO_{ð}, H_{x′}PO_{Ð′}, (NH_{w})ₓP_{y}O_{Ð}, (NH_{w})ₓM_{y}P_{z}O_{Ð}, HₓV_{z}O_{Ð}, HₓM_{y}V_{z}O_{Ð}, HₓM_{y}M_{z}O_{Ð}, HₓM_{y}W_{z}O_{Ð}, HₓM_{y}B_{z}O_{Ð}, with at least one materials selected from the group consisting of: ZnI_{ð}, ZnCl_{ð}, CuCl_{ð}, MoCl_{ð}, CoCl_{ð}, BiCl_{ð}, NiCl_{ð}, PCl_{ð}, LiCl, LiF, FeCl_{ð}, metal halides; HₓM_{y}Mo_{z}O_{≃}; the partially inorganic deep eutectic solvents; inorganid deep eutectic solvents doped with choline halides, urea, (di)carboxylic acids, ADP, ATP, ethylene glycol, PEG, ethylene oxide, PEO, polyethylene dimethyl ether, polyethylene monomethyl ether, propylene glycol, PPG, polypropylene dimethyl ether, polypropylene monomethyl ether, ethoxylates, alcohol ethoxylates, poloxamers or a combination thereof; HₓM_{y}W_{z}O_{Ð}; HₓM_{y}B_{z}O_{Ð}; M_{y}(NO_{ð})_{z}; M_{y}(CO_{ð}); HₓV_{y}O_{ð}; HₓM_{y}V_{z}O_{ð}; NaₓV_{y}O_{ð}; LiₓV_{y}O_{ð}; KₓV_{y}O_{ð}; (NH_{w})ₓV_{y}O_{ð}; HₓV_{y}O_{ð}, HₓM_{y}V_{z}O_{ð}, NaₓV_{y}O_{ð}, LiₓV_{y}O_{ð}, KₓV_{y}O_{ð}, (NH_{w})ₓV_{y}O_{ð}, with at least one materials selected from the group consisting of: ZnI_{ð}, ZnCl_{ð}, CuCl_{ð}, MoCl_{ð}, CoCl_{ð}, BiCl_{ð}, NiCl_{ð}, PCl_{ð}, LiCl, LiF, FeCl_{ð}, metal halides; H_{w}MₓP_{y}V_{z}O_{ð}; phosphovanadates; mixtures of metal halides;
mixtures of alkali halides; LiX: NaX: KX; high entropy liquid mixtures including at least three species of salts selected from the group consisting of: N_{w}HₓM_{y}V_{z}O_{ð}, N_{w}HₓM_{y}Mo_{z}O_{ð}, N_{w}HₓM_{y}W_{z}O_{ð}, N_{w}HₓM_{y}B_{z}O_{ð}, N_{w}HₓM_{y}P_{z}O_{ð}, M_{y}(CO₃)ₓ, M_{y}Oₓ(CO₃)_{z}, M_{y}NO_{ð}, LiX, NaX, KX, SnX, MgX, MnX, ZnX, BiX, MoX, FeX Ammonium X, SnO_{ð}, PbO_{ð}, AgO_{ð}, MnO_{ð}; metal carbonates; Li₂CO₃; Na₂CO₃; K₂CO₃; Laₓ(CO₃)_{y}; LaₓO_{y}(CO₃)_{z}; mixtures of metal carbonates and metal nitrates; LiNO_{ð}; NaNO_{ð}; KNO_{ð}; mixtures of carbonates; diphenyl carbonate; ethyl phenyl carbonate; alkyl phenyl carbonates; ethylene carbonates; dimethyl carbonate; propylene carbonate; mixtures of carbonates with at least one metal selected from the group consisting of: Ag, Sn, Pb, Sb, Ga, Zn, Bi, In, Cu, Pd, Pt, Li, Mn, Mg, Fe Hg or oxides thereof; VₓO_{ð}; MoₓO_{ð}; WₓO_{ð}; HₓLi_{y}Mn_{z}O_{ð}; HₓSr_{y}Co_{z}O_{ð}; SiₓO_{ð}; AlₓO_{ð}; CeₓO_{ð}; LaₓSr_{y}Cr_{z}Mn_{w}MᵥO_{ð}, YₓCe_{y}O_{ð}, SrₓMo_{y}Mn_{z}O_{ð}, ErₓDy_{y}Bi_{z}O_{ð}, Sm_{w}Gd_{y}CeₓM_{z}O_{ð}; Y_{y}ZrₓO_{ð}; ZrₓO_{ð}; MgO_{ð}; TiO_{ð}; NiO_{ϵ}; FeₓO_{ð}; AlₓMg_{y}O_{ð}; Li_{w}NiₓCo_{y}Al_{z}O_{ð}; La_{w}SrₓCr_{y}Mn_{z}O_{ð}; La_{w}SrₓCo_{y}Fe_{z}O_{ð}; Ba_{w}SrₓCo_{y}Fe_{z}O_{ð}; BiₓSr_{y}Co_{z}O_{ð}; PrₓBa_{w}SrₓCo_{y}Fe_{z}O_{ð}; PrₓBa_{y}Co_{z}O_{ð}; SmₓSr_{y}Co_{z}O_{ð}; Pr_{y}Ni_{z}O_{ð}; La_{y}Ni_{z}O_{ð}; Bi_{y}Ru_{z}O_{ð}; BaₓZr_{y}Y_{z}O_{3-ð}; BaᵥCo_{w}FeₓZr_{y}Y_{z}O_{ð}; LaₓBa_{w}SrₓCo_{y}Fe_{z}O_{ð}; BaₓCe_{y}Y_{z}O_{3″ð}; Ba_{w}ZrₓCe_{y}Y_{z}O_{3-ð}; BaᵤZrᵥCe_{w}YₓYb_{y}O_{3-ð}; BaᵤZrᵥSn_{w}TiₓHf_{y}Y_{z}O_{ð}; BaᵤZrᵥGa_{w}TiₓHf_{y}Y_{z}O_{ð}; SmₓNi_{y}O_{3-ð}; Pd; PdₓAu_{y}; PdₓH_{y}; PdₓAg_{y}; PdₓPt_{y}; PdₓRh_{y}; PdₓCu_{y}; PdₓOs_{y}; PdₓRu_{y}; PdₓTa_{y}; graphene; a carbon molecular sieve; zeolites; amorphous silica; carbon nanotubes; Sr_{w}FeₓTi_{y}Zn_{z}O_{ð}; PrᵤBaᵥZr_{w}Ce_{y}Y_{z}YbₛO_{3-ð}; NbₓTi_{y}O_{3-ð}; HₓSr_{y}Co_{z}O_{ð}; HₓLi_{y}Mn_{z}O_{ð}; HₓMo_{y}O_{ð}; HₓW_{y}O_{α}; La_{w}SrₓGa_{y}Mg_{z}O_{ð}; Li; Ga; Zn; Sn; In; Mg; Mn; Al; Sb; Pb; Hg; P; Na; Cs; Bi; Ce; NiₓMo_{y}Bi_{z}; Sn_{w}NiₓMo_{y}Bi_{z}; Sn_{w}NiₓMo_{y}Sb_{z}; ZnₓCu_{y}; ZnₓMo_{y}Ni_{z}; CuₓNi_{y}Sn_{z}; ZnₓMo_{y}Co_{z}; ZnₓSn_{y}; SnₓBi_{y}; SnₓPb_{y}; ZnₓPb_{y}; BiₓPb_{y}; ZnₓGa_{y}; TlₓPb_{y}; TlₓGa_{y}; TlₓZn_{y}; ZnₓCu_{y}; ZnₓMo_{y}Ni_{z}; ZnₓMo_{y}Co_{z}; SbₓSn_{y}; SbₓPb_{y}; MoₓNi_{y}Sb_{z}Sn_{ð}; MoₓNi_{y}Sb_{z}Pb_{ð}; ZnₓSn_{y}Cu_{z}; ZnₓSn_{y}Ni_{z}; ZnₓSn_{y}In_{z}; SnₓBi_{y}In_{ð}; ZnᵤSnᵥInₓBi_{w}Ni_{y}Mo_{z}Cu_{ð}; ZnᵤSnᵥInₓBi_{w}Ni_{y}Mo_{z}Cu_{ð}; at least one of the aforementioned low melting point metals, alloys, or both doped with at least one catalytic element selected from the group consisting of: Cu, Ni, Mo, W, Co, Fc, V, Ir, Pt, Pd, Dy, Ru, Rh, Os, Si, Ge, Tl; at least one of the aforementioned low melting point metals, alloys, or both partially oxidized; Pt; Ru; Rh; Ir; Ag; Re; Pd; Au; Ni; Co; Cu; In; Cd; Al; Os; V; Ti; Mo; Si; Ge; Tl; Li; Mg; Ca; Ce; Zr; BₓN_{y}; GaₓAs_{y}; MnₓN_{y}; MoₓCo_{y}N_{z}; iron nitrides; lanthanum nitride; lanthanum aluminum nitride; aluminum nitride; iron phosphide; molybdenum phosphide; cobalt phosphide; carbides; carbon-allotrope coated carbides; graphene coated carbides; nitrogen or phosphide doped carbides; BaₓC_{y}; SrₓC_{y}; CaₓC_{y}; FcₓC_{y}; MoₓC_{y}; WₓC_{y}; WₓC_{y}N_{z}P_{ð}; TiₓC_{y}; NiₓC_{y}; CoₓC_{y}; CrₓC_{y}; RuₓC_{y}; PtₓC_{y}; SiC_{y}; YₓC_{y}; CrₓC_{y}; HfₓC_{y}; ZrₓC_{y}; TaₓC_{y}; CeₓC_{y}; LaₓC_{y}; GdₓC_{y}; at least one of the aforementioned carbides doped with nitrogen; V_{w}CₓN_{α}C_{β}S_{γ}; VₓP_{y}C_{z}; Fe_{y}V_{z}CₓN_{w}; Ti_{y}V_{z}CₓN_{w}; Mo_{y}Co_{z}CₓN_{w}; LiᵥV_{w}MoₓCo_{y}W_{z}N_{α}C_{β}S_{γ}; LiᵤFeᵥV_{w}MoₓCo_{y}W_{z}N_{α}C_{β}S_{γ}; LiᵤTiᵥV_{w}MoₓCo_{y}W_{z}N_{α}C_{β}S_{γ}; LiᵤNiᵥV_{w}MoₓCo_{y}W_{z}N_{α}C_{β}S_{γ}; LiᵤCuᵥV_{w}MoₓCo_{y}W_{z}N_{α}C_{β}S_{γ}; MnᵤNᵥMo_{w}CoₓNi_{y}C_{z}—Ba_{α}H_{ð}; MnₜNᵤWᵥMo_{w}CoₓNi_{y}C_{z}—BaₓH_{ð}; MnₛNₜVᵤFeᵥMo_{w}CoₓNi_{y}C_{z}—BaₓH_{ð}; photo-catalysts/plasmonic catalysts including MoₓS_{ð}; CuₓZn_{y}Sn_{z}S_{ð}; CuₓIn_{z}S_{ð}; CuₓSb_{z}S_{ð}; CdₓS_{ð}; TiₓN_{α}O_{β}C_{γ}S_{ð}; ZrₓN_{α}O_{β}C_{γ}S_{ð}; VₓN_{α}O_{β}C_{γ}S_{ð}; CoᵤNiᵥCu_{w}RuₓPd_{y}Pt_{z}V_{ð}; CoᵤMoᵥFe_{w}NiₓCu_{y}W_{z}V_{ð}; IrᵥPd_{w}RhₓRu_{y}Pt_{z}V_{ð}; TiᵤVᵥCr_{w}MnₓMo_{y}Ce_{z}; NiᵤCo_{w}FeₓCr_{y}Pt_{z}V_{ð}; AlᵥNi_{w}CuₓPt_{y}Mn_{z}; PtᵤNiᵥCo_{w}FeₓMo_{y}Ru_{z}V_{ð}; PtᵥRh_{w}MoₓFe_{y}Mn_{z}; supercritical fluids, supercritical CH₄; supercritical H₂S; supercritical H₂O; supercritical COₓ; supercritical light hydrocarbons; supercritical alcohols; atomic carriers; molecular carriers; hydrogen carrier; nitrogen carrier; oxygen carrier; carbon carrier; sulfur carriers; ionic conductors; proton conductor; hydride conductor; oxide conductor; ammonium conductor; lithium conductors; carbides, MXenes, or both consisting of at least one material selected from the group of VₓC_{y}, TiₓC_{y}, MoₓC_{y}, WₓC_{y}, YₓC_{y}, CrₓC_{y}, HfₓC_{y}, ZrₓC_{y}, TaₓC_{y}, CeₓC_{y}, LaₓC_{y}, GdₓC_{y}, rare earth carbides, or compounds thereof; zeolites; molecular sieves; polymeric ion conductors; Nafion, polybenzimidazole [PBI]; polypyridobisimidazole [PPI]; polyethersulfone; polyvinylpyrrolidone; PTFE; PVDF; fluorinated polymers; fluorocarbons; sulfonates; at least one of the aforementioned polymeric ion conductors further doped with at least one of the following materials selected from the group of: phosphoric acid, sulfuric acid, phosphonic acid, ethylenediamine tetramethylene phosphonic acid, CₓN_{2+y}(C_{z}PO₃H₂)_{4+ð}, an inorganic deep eutectic solvent; phosphoric acid; phosphonic acid ethylenediamine tetramethylene phosphonic acid; CₓN_{2+y}(C_{z}PO₃H₂)_{4+ð}; NaOH; KOH; ionic liquids; NᵤHᵥM_{w}P_{z}O_{α}Cl_{β}I_{γ}; NᵤHᵥSn_{w}GaₓZn_{y}P_{z}O_{α}Cl_{β}I_{γ}; LiX:KX:V_{z}O_{α}:HₓMo_{y}O_{α″}:H_{x′}W_{y′}O_{α″}:H_{x″}Sr_{y″}Co_{z″}O_{a′41} ; NₓH_{y}Mg_{z}Cl_{α}; NₓH_{y}Ti_{z}F_{α}; NₓH_{y}M_{z}X_{α}; hydrides; imides; nitrides heterostructures involving hydrides imides and nitrides; BaₓN_{y}H_{z}; Mn_{w}NₓBa_{y}H_{z}; NiₓBa_{y}H_{z}; NiᵤCoᵥMn_{w}NₓBa_{y}H_{z}; MoᵤCoᵥMn_{w}NₓBa_{y}H_{z}; FeᵥMn_{w}NₓBa_{y}H_{z}; LaₓN_{y}H_{z}; LiₓN_{y}H_{z}; CaₓN_{y}H_{z}; VN_{y}H_{z}; TiN_{y}H_{z}; MoᵤCoᵥMn_{w}NₓK_{y}H_{z}; MoᵤCoᵥMn_{w}NₓNa_{y}H_{z}; FeᵥMn_{w}NₓK_{y}H_{z}; FeᵥMn_{w}NₓNa_{y}H_{z}; at least one of the aforementioned hydrides, imides nitrides, carbides, or combinations thereof encapsulated in a carbon-allotropes; the aforementioned containing H₂O; the aforementioned containing H₂S; plasmonic materials; TiN_{α}O_{β}C_{γ}S_{ð}; ZrN_{α}O_{β}C_{γ}S_{ð}; VN_{α}O_{β}C_{γ}S_{ð}; AuₓLi_{y}S_{ð}; MoS_{ð}; Au_{z}Li_{y}S_{ð}; VₓCu_{y}S_{ð}; CuᵥZnₓSn_{y}S_{ð}; hydroxides; Niₓ(OH)_{y}; Cuₓ(OH)_{y}; transition metal hydroxides; silver fluoride; transition metal fluorides;
silicon oils; polydimethylsiloxane; diphenyl-dimethylsiloxane: phenylmethylsiloxane: “Fragol” style silicon oils; diphenyl oxide/biphenyl eutectics; perfluoropolyethers; nanofluids of the aforementioned high temperature oils; dimethylformamide or related salts; guadinine or related salts; formamidine or related salts; Ce_{α}Au_{β}CₓS_{y}N_{z}O_{ð}; Ce_{α}Pt_{β}CₓS_{y}N_{z}O_{ð}; Ce_{α}Li_{β}CₓS_{y}N_{z}O_{ð}; Ce_{α}Li_{β}Mn_{γ}CₓS_{y}N_{z}O_{ð}; Ce_{α}Li_{β}Mn_{γ}Bi_{δ}CₓS_{y}N_{z}O_{ð}; Ce_{α}Li_{β}Mn_{γ}Bi_{δ}Au_{ε}CₓS_{y}N_{z}O_{ð}; Ce_{α}Li_{β}Mn_{γ}Bi_{δ}Pt_{ε}CₓS_{y}N_{z}O_{ð}; Ce_{α}Li_{β}Mn_{γ}Bi_{δ}Ag_{ε}CₓS_{y}N_{z}O_{ð} the aforementioned doped with Gd or Sm; Li_{α}Mo_{β}CₓS_{y}N_{z}O_{ð}; Mn_{α}Mo_{β}CₓS_{y}N_{z}O_{ð}; Li_{α}Na_{β}CₓS_{y}N_{z}O_{ð}; Li_{α}Na_{β}P_{γ}SₓC_{y}N_{z}O_{ð}; Li_{α}Ge_{β}P_{γ}CₓS_{y}N_{z}O_{ð}; Li_{α}Na_{β}P_{γ}CₓS_{y}N_{z}O_{ð}; Li_{α}Si_{β}P_{γ}CₓS_{y}N_{z}O_{ð}; Li_{α}Na_{β}Sr_{γ}Zr_{δ}P_{ε}CₓS_{y}N_{z}O_{ð}; Li_{α}Na_{β}Mn_{γ}Zn_{δ}P_{w}CₓO_{ð}X_{z}; Li_{α}Si_{β}P_{γ}X_{δ}CₓS_{y}N_{z}O_{ð}; Li_{α}La_{β}Zr_{γ}CₓS_{y}N_{z}O_{ð}; Li_{α}La_{β}Ce_{γ}CₓS_{y}N_{z}O_{ð}; Li_{α}Na_{β}Zr_{γ}P_{δ}CₓS_{y}N_{z}O_{ð}; Li_{═}Ce_{β}P_{γ}CₓS_{y}N_{z}O_{ð}; CaCₓS_{y}N_{z}O_{ð}; AgLiCₓS_{y}N_{z}O_{ð}; MnCₓS_{y}N_{z}O_{ð}; MgCₓS_{y}N_{z}O_{ð}; ZnCₓS_{y}N_{z}O_{ð}; Li_{α}Y_{β}Zr_{γ}CₓS_{y}N_{z}O_{ð}; Mn_{α}Y_{β}Zr_{γ}CₓS_{y}N_{z}O_{ð}; Mg_{α}Y_{β}Zr_{γ}CₓS_{y}N_{z}O_{ð}; Ca_{α}Y_{β}Zr_{γ}CₓS_{y}N_{z}O_{ð}; Li_{α}V_{β}CₓS_{y}N_{z}O_{ð}; La_{α}Sr_{β}V_{γ}CₓS_{y}N_{z}O_{ð}; Gd_{α}Ti_{β}Mo_{γ}CₓS_{y}N_{z}O_{ð}; Bi_{α}Me_{β}V_{γ}CₓS_{y}N_{z}O_{ð}; Dy_{α}Gd_{β}Bi_{γ}Li_{δ}CₓS_{y}N_{z}O_{ð}; Dy_{α}Gd_{β}Bi_{γ}Mn_{δ}CₓS_{y}N_{z}O_{δ}; Dy_{α}Gd_{β}Bi_{γ}Mg_{δ}CₓS_{y}N_{z}O_{ð}; Dy_{α}Gd_{β}Bi_{γ}Ca_{δ}CₓS_{y}N_{z}O_{ð}; BaZrYCₓS_{y}N_{z}O_{ð}; BaCeYCₓS_{y}N_{z}O_{ð}; Co_{α}Ni_{β}Zn_{γ}In_{δ}CₓS_{y}N_{z}O_{ð}; Li_{α}Na_{β}Me_{γ}Te_{ε}CₓS_{y}N_{z}O_{ð}; exsolutions of M; MCₓS_{y}N_{z}O_{ð} exsolutions; or combinations thereof;
and wherein M consists of at least one species selected from the group of: a transition metal, an alkali metal, an alkali carth metal, a lanthanide, an actinide, Si, Ge, Bi, B, Sb, As, Te, or combinations thereof; and
wherein X is a halide: and wherein subscripts u, v, w, x, y, z, α, β, ð, γ and ø are independent from a selected material to another selected material and range between 0 and 5 including all values between 0 and 5, 0, and 5, where physically applicable.

18. A method of electrochemically or chemically reacting oxygen or oxygen containing ion with at least one cation or one cation with an electron, in order to produce an oxygen containing species by the means contacting a cationic conductor, or an electrode in contact with a cationic conductor, or both with at least one liquid selected from the group consisting of: an oxygen bearing liquid or multiphase fluid, an oxygen ion bearing liquid or multiphase fluid, an oxygen bearing liquid ion, or a combination thereof;
wherein at least one of the following: the liquid, liquid ion, or the multiphase fluid, contains at least one material selected from the group consisting of: an inorganic deep eutectic solvent, a molten salt, an ionic liquid, a deep eutectic solvent, or a combination thereof.

19. A method of claim 18, wherein the liquid or multiphase fluid either: contains at least one anion selected from the group consisting of: carbonates, nitrates, molybdates, vanadates, phosphates, halides or a combination thereof, and at least one cation selected from the group consisting of: H, Li, Na, K, alkali metals, alkaline carth metals, Zn, Cu, Ni, Ti, Mg, Mn, Sn, Bi, transition metals, ammonium, or a combination thereof; or contains a liquid metal consisting of at least one metal selected from the group consisting of Ag, Os, Tl, Ba, Pb, Sr, Sb, Li, Sn, Bi, In, Cd, Zn, Cu, Fc, Co, Hg, Ce, Au, Pt, Pd, Ir, Ru, Rh, the oxides thereof or a combination thereof; or contains both.

20. A method of chemically reacting H₂S containing material stream, a nitrogen containing stream or both in order to produce at least one of the products selected from the group consisting of: hydrogen, ammonia, or both, by the means contacting the materials stream with at least one fluid selected from the group consisting of: an inorganic deep eutectic solvent, a molten salt, a partially inorganic deep eutectic solvent, a liquid metal or a combination thereof, wherein an optional catalyst consisting of at least one material selected from a group consisting of: nitrides, imides, hydrides, the aforementioned coated in a carbon allotrope, or a combination thereof.

21. A method of claim 20, wherein the fluid or multiphase fluid contains at least one anion selected from the group consisting of: phosphates, phosphonates, nitrates, nitrites, carbonates, molybdates, vanadates, halides, imides, nitrides, hydrides, or a combination thereof, and at least one cation or metal selected from the group consisting of: H, Au, Zn, Cu, Ni, Ti, Mg, Mn, Sn, Bi, transition metals, Li, Na, K, alkali metals, Ba, Sr, Ca, alkaline carth metals, rare earth metals, ammonium, or a combination thereof; and wherein the optional catalyst could be coated with graphene or a carbon allotrope.

22. A method of contacting an H₂S containing stream with an inorganic deep eutectic solvent or partially inorganic deep eutectic solvent in order to produce hydrogen, ammonia or both, wherein the temperature of the solvent is between −20° C. and 400° C. and the inorganic deep eutectic solvent consists of at least two of the following materials selected from the group consisting of: MᵥN_{w}HₓP_{y}O_{ð}, MᵥN_{w}HₓMo_{y}O_{ð}, MᵥN_{w}HₓW_{y}O_{ð}, MᵥN_{w}HₓB_{y}O_{ð}, MᵥN_{w}HₓV_{y}O_{ð}, a metal halide, a semi-metal halide, H₂O, or compounds thereof; wherein M consists of at least one species selected from the group of: a transition metal, an alkali metal, an alkali carth metal, a lanthanide, an actinide, Si, Ge, Bi, B, Sb, As, Te, or combinations thereof; and wherein subscripts v, w, x, y, and ð are independent from a selected material to another selected material and range between 0 and 5 including all values between 0 and 5, 0, and 5, where physically applicable; and wherein an optional nitrogen containing stream is further contacted with at least one item selected from the group consisting of: the inorganic deep eutectic solvent, the H₂S containing stream, a catalyst, or a combination thereof; and
wherein an optional ammonia producing catalyst is within the inorganic deep eutectic solvent, and consists of at least one of the following catalysts selected from the group of: metal nitride, metal carbide, metal hydride, metal imide, lithium, a carbon allotrope, at least one of the aforementioned catalysts coated with a carbon allotrope, or a combination thereof.

23. A chemical or electrochemical method to at least partially amend a structural imperfection, a fluid containment imperfection, or both of a solid ionic conductor or a partially solid ionic conductor in an operating electrochemical device by the means of at least one of the following actions carried on at least one liquid or multiphase fluid selected from the group consisting of: oxidation, nitridation, reduction, infusion, adhesion, anchoring, diffusion, physically plugging, increasing pressure, reducing pressure, or a combination thereof;
wherein optionally at least one liquid, multiphase fluid, or both initially consists of a material selected from the group consisting of: a liquid metal, a metal, a metal oxide, a semiconductor, a semiconductor oxide, a semi-metal, a semi-metal oxide, metal carbonate, metal nitrate, metal halide, a molten salt or a combination thereof;
wherein optionally the initial material, the produced material or both further reacts with the solid ionic conductor to produce a subsequent material;
and wherein optionally reducing or avoiding at least one of the following items selected from a group consisting of: device failure, catastrophic failure, device performance degradation, electrical shorting, material streams mixing or a combination thereof.

24. An apparatus comprising a reactor for chemical reactions, electrochemical reactions or both with at least one input port and at least one output port to process a material stream;
wherein the reactor comprises at least one of the following ionic conductors selected from the group consisting of: a cationic ion conductor, hydride ion conductor, or a combination thereof, separating at least two electrodes, wherein at least one electrode is a liquid electrode or a multiphase fluid electrode, wherein the electrode consists of at least one material selected from the group consisting of: a liquid metal, a molten salt, an inorganic deep eutectic solvent, a partially inorganic deep eutectic solvent, a supercritical fluid, a nanofluid consisting at least partially of at least one of the aforementioned liquids or multiphase fluids, at least one of the aforementioned further consisting of H₂O, or a combination thereof;
and wherein at least one of the input ports is in fluid contact with at least one of the electrodes;
and wherein optionally the reactor further comprises of a further oxide conductor, a hydroxide conductor or both;
and wherein optionally one or more electrodes could consist of a solid metal electrode; wherein optionally an electrode further consists at least for a material selected from the group of high temperature oils, water, hydrocarbons or a combination thereof;
and wherein the reactor further comprises a cavitation inducing device, a Venturi injector or both.

25. An apparatus to induce cavitation on a material stream consisting of at least one material selected from the group of: a moten salt, an inorganic deep eutectic solvent, a partially inorganic deep eutectic solvent, a supercritical fluid, a liquid metal, an amide-group containing solvent, a metal fluoride, a nanofluid consisting of at least one of the aforementioned liquids, the aforementioned further consisting of H₂O, or a combination thereof; an optional further input material stream; and wherein the apparatus further comprises of at least one dynamic cavitation inducing geometry selected from the group consisting of: Venturi injector, vortex diode, a Helmholz resonator, a rotor-stator, a swirl inducing element or a combination thereof; wherein a localized material stream pressure is initially decreased allowing for part of the fluid to vaporize; wherein an optional element includes a pump.
